(19) United States
(12) Patent Application Publication
(10) Pub. No.: US 2016/0118664 A1
(43) Pub. Date: Apr. 28, 2016

(54) SLURRY COMPOSITION FOR SECONDARY-BATTERY NEGATIVE ELECTRODE, SECONDARY-BATTERY NEGATIVE ELECTRODE, AND SECONDARY BATTERY

(71) Applicant: ZEON CORPORATION, Tokyo (JP)

(72) Inventor: Kenya SONOBE, Chiyoda-ku, Tokyo (JP)

(73) Assignee: ZEON CORPORATION, Chiyoda-ku, Tokyo (JP)

(21) Appl. No.: 14/890,672

(22) PCT Filed: May 23, 2014
(86) PCT No.: PCT/JP2014/002733

§ 371 Date: Nov. 12, 2015

(30) Foreign Application Priority Data
May 23, 2013 (JP) 2013-109351

(51) Int. Cl. H01M 4/62; H01M 10/0525

(52) U.S. Cl. CPC H01M 4/622; H01M 10/0525; H01M 2220/20; H01M 2220/30; H01M 2220/10

(57) ABSTRACT

The disclosed slurry composition for a secondary-battery negative electrode includes a water-soluble thickener (A) having a hydroxy group or a carboxyl group, a cross-linking agent (B) having a functional group reactive with the hydroxy group or the carboxyl group, a particulate polymer (C) having a functional group reactive with the cross-linking agent (B), a negative electrode active material containing a non-carbon-based negative electrode active material, and water. The slurry composition contains 0.5 to 20 mass parts of the water-soluble thickener (A), 0.001 to 10 mass parts of the cross-linking agent (B), and 0.5 to 20 mass parts of the particulate polymer (C), per 100 mass parts of the negative electrode active material.

### TECHNICAL FIELD

The disclosure relates to a slurry composition for a secondary-battery negative electrode, a secondary-battery negative electrode, and a secondary battery.

### BACKGROUND

Secondary batteries, such as lithium ion secondary batteries, are small and light, high in energy density, and rechargeable. For such characteristics, secondary batteries are used in a wide variety of applications. Therefore, in recent years, for the purpose of achieving higher performance of secondary batteries, studies have been made to improve battery members such as electrodes.

Battery members such as electrodes (positive electrode and negative electrode) of a secondary battery are formed by binding together components contained in those battery members or binding those components and substrates (e.g., current collectors, etc.) using a binder. Specifically, for example, a negative electrode of a secondary battery usually includes a current collector and a negative-electrode mixed material layer formed on the current collector. The negative-electrode mixed material layer is formed for example by applying, onto a current collector, a slurry composition for an electrode obtained by dispersing, for example, a particulate polymer and a negative electrode active material into a dispersing medium, and drying the applied slurry composition to bind the negative electrode active material and the like using the particulate polymer as a binder.

In order to further increase the performance of secondary batteries, in recent years, attempts have been made to improve the slurry composition for an electrode used to form those battery members.

Specifically, for example, there has been proposed to improve the performance of a secondary battery by blending a cross-linking agent into a slurry composition for an electrode used to form electrodes of a secondary battery, and forming electrodes using the slurry composition for an electrode. For example, JP2000-106189A (PTL 1) proposes a secondary battery having a negative electrode comprising a mixed agent including a negative electrode active material, a binding agent, a thickener such as carboxymethyl cellulose, and at least one cross-linking agent selected from the group consisting of a melamine-based resin, a urea formalin resin, tannic acid, a glyoxal-based resin, a dimethylol compound, and PVA. PTL 1 further discloses, for example, that the cross-linking agent allows cross-linking to occur between the carboxymethyl celluloses contained as the thickener.

Further, for example, JP2011-134618A (PTL 2) proposes a secondary-battery electrode formed with a binder composition for a secondary-battery electrode including functional group-containing resin fine particles obtained by emulsion polymerizing ethylenic unsaturated monomers containing keto-group containing ethylenic unsaturated monomers and a multifunctional hydrazide compound as a cross-linking agent. PTL 2 further discloses that the multifunctional hydrazide compound allows cross-linking to occur between the functional group-containing resin fine particles.

Still further, for example, JPH11-288741A (PTL 3) proposes a lithium ion secondary battery having a porous membrane on at least one of a positive electrode and a negative electrode. The positive electrode or the negative electrode is formed with a binding agent including a water-soluble polymer material having a hydroxy group and a cross-linking agent having a functional group reactive with the hydroxy group. PTL 3 further discloses that the cross-linking agent allows cross-linking to occur between the water-soluble polymer materials.

Still further, for example, WO2010/114119A (PTL 4) proposes a secondary-battery electrode formed with a binder composition for a non-aqueous secondary battery electrode, which includes functional group-containing cross-linked resin fine particles obtained by copolymerizing monomers including an ethylenic unsaturated monomer having a specific functional group. PTL 4 further discloses that a compound having at least one functional group selected from an epoxy group, an amido group, a hydroxy group, and an oxazoline group is cross-linked with the functional group-containing cross-linked resin fine particles via a cross-linking agent.

### CITATION LIST

### Patent Literature

PTL 1: JP2000-106189A

PTL 2: JP2011-134618A

PTL 3: JPH11-288741A

PTL 4: WO2010/114119A

### SUMMARY

### Technical Problem

To further improve the performance of secondary batteries, there has been a need for a secondary-battery electrode that exhibits superior adherence between a current collector and an electrode mixed material layer and can improve the electrical characteristics of a secondary battery (e.g., initial coulombic efficiency, initial resistance, cycle characteristics, resistance rise rate, etc.).

However, the above-described conventional secondary-battery electrodes are not capable of concurrently achieving the superior adherence between a current collector and an electrode mixed material layer and good electrical characteristics of secondary batteries at a sufficiently high level.

Further, in recent years, to increase the capacity of secondary batteries, a use of a negative electrode active material containing a non-carbon-based negative electrode active material has been proposed for secondary-battery negative electrodes. However, such a secondary-battery negative electrode including a negative electrode active material containing a non-carbon-based negative electrode active material readily expands in accordance with charge and discharge, failing to improve the electrical characteristics such as cycle characteristics sufficiently. Therefore, there has been a need for a secondary-battery negative electrode that can achieve both of superior adherence between a current collector and a negative-electrode mixed material layer and good electrical characteristics of a secondary battery at a sufficiently high level even when a negative electrode active material containing a non-carbon-based negative electrode active material is used.

It could therefore be helpful to provide a slurry composition for a secondary-battery negative electrode that allows formation of a negative-electrode mixed material layer that exhibits superior adherence to a current collector and can improve the electrical characteristics of a secondary battery, even when a negative electrode active material containing a non-carbon-based negative electrode active material is used.

It could also be helpful to provide a secondary-battery negative electrode that includes a negative electrode active material containing a non-carbon-based negative electrode active material, which exhibits superior adherence between a current collector and a negative-electrode mixed material layer and can improve the electrical characteristics of a secondary battery.

It could also be helpful to provide a secondary battery comprising a secondary-battery negative electrode that includes a negative electrode active material containing a non-carbon-based negative electrode active material, which exhibits superior adherence between a current collector and a negative-electrode mixed material layer and also exhibits superior electrical characteristics.

### Solution to Problem

As a result of extensive studies made to achieve the above objects, the disclosure newly discovered that a slurry composition for a secondary-battery negative electrode described below allows formation of a negative-electrode mixed material layer that exhibits superior adherence to a current collector and can improve the electrical characteristics of a secondary battery, even when a negative electrode active material containing a non-carbon-based negative electrode active material is used, and the products were fabricated as disclosed herein. The slurry composition for a secondary-battery negative electrode includes a water-soluble thickener (A) having a hydroxy group or a carboxyl group, a cross-linking agent (B) having a functional group reactive with the hydroxy group or the carboxyl group of the water-soluble thickener (A), and a particulate polymer (C) having a functional group reactive with the cross-linking agent (B), wherein the blending ratio of each of the water-soluble thickener (A), the cross-linking agent (B), and the particulate polymer (C) to a negative electrode active material is within a specific range.

Specifically, with a view to advantageously solving the above-mentioned problems, the slurry composition for a secondary-battery negative electrode of the disclosure includes a water-soluble thickener (A) having a hydroxy group or carboxyl group, a cross-linking agent (B) having a functional group reactive with the hydroxy group or the carboxyl group of the water-soluble thickener (A), a particulate polymer (C), a negative electrode active material, and water. The negative electrode active material contains a non-carbon-based negative electrode active material, and the particulate polymer (C) has a functional group reactive with the cross-linking agent (B). The slurry composition for a secondary-battery negative electrode contains 0.5 mass parts or more but 20 mass parts or less of the water-soluble thickener (A), 0.001 mass parts or more but 10 mass parts or less of the cross-linking agent (B), and 0.5 mass parts or more but 20 mass parts or less of the particulate polymer (C), per 100 mass parts of the negative electrode active material. As described, by using the negative electrode active material containing a non-carbon-based negative electrode active material, a slurry composition for a secondary-battery negative electrode that allows formation of a negative electrode that can increase the capacity of a secondary battery can be obtained. Further, by blending the water-soluble thickener (A) having a hydroxy group or a carboxyl group, the cross-linking agent (B) having a functional group reactive with the hydroxy group or the carboxyl group, and the particulate polymer (C) having a functional group reactive with the cross-linking agent (B), and adjusting the blending ratio of each of the water-soluble thickener (A), the cross-linking agent (B), and the particulate polymer (C) to the negative electrode active material within a specific range, a slurry composition for a secondary-battery negative electrode that allows formation of a negative-electrode mixed material layer that exhibits superior adherence to a current collector and can improve the electrical characteristics of a secondary battery can be obtained, even when the negative electrode active material containing a non-carbon-based negative electrode active material is used.

The term “non-carbon-based negative electrode active material” as used herein refers to any active material excluding carbon-based negative electrode active materials consisting exclusively of a carbonaceous material or a graphitic material.

The water-soluble thickener (A) included in the slurry composition for a secondary-battery negative electrode of the disclosure is preferably at least one selected from the group consisting of carboxymethyl cellulose, methyl cellulose, hydroxypropyl methylcellulose, hydroxyethyl methylcellulose, polyvinyl alcohol, polycarboxilic acid, and salts thereof. When the water-soluble thickener (A) is at least one selected from the above group, good workability can be achieved in applying the slurry composition for a secondary-battery negative electrode onto a substrate, such as a current collector.

The cross-linking agent (B) included in the slurry composition for a secondary-battery negative electrode of the disclosure is preferably at least one compound selected from the group consisting of a multifunctional epoxy compound, an oxazoline compound, and a carbodiimide compound. When the cross-linking agent (B) is at least one compound selected from the above group, the stability of the slurry composition for a secondary-battery negative electrode can be ensured and the electrical characteristics of a secondary battery formed with the slurry composition for a secondary-battery negative electrode is further improved.

The particulate polymer (C) included in the slurry composition for a secondary-battery negative electrode of the disclosure preferably includes an aliphatic conjugated diene monomer unit and an aromatic vinyl monomer unit. When the particulate polymer (C) includes an aliphatic conjugated diene monomer unit and an aromatic vinyl monomer unit, the negative electrode formed with the slurry composition for a secondary-battery negative electrode further improves the adherence between a current collector and a negative-electrode mixed material layer.

The functional group reactive with the cross-linking agent (B) in the particulate polymer (C) included in the slurry composition for a secondary-battery negative electrode of the disclosure is preferably at least one group selected from the group consisting of a carboxyl group, a hydroxy group, a glycidyl ether group, and a thiol group. When the functional group reactive with the cross-linking agent (B) in the particulate polymer (C) is at least one group selected from the above group, good electrical characteristics such as good cycle characteristics of the secondary battery obtained with the slurry composition for a secondary-battery negative electrode can be achieved.

Further, with a view to advantageously solving the above-mentioned problems, the secondary-battery negative electrode of the disclosure has a negative-electrode mixed material layer obtained from any of the above-described slurry compositions for a secondary-battery negative electrode. As described, the formation of a negative-electrode mixed material layer on a current collector using the above-mentioned slurry composition for a secondary-battery negative electrode provides a secondary-battery negative electrode that includes a negative electrode active material containing a non-carbon-based negative electrode active material, which exhibits superior adherence between the current collector and the negative-electrode mixed material layer and can improve the electrical characteristics of a secondary battery.

Here, the negative-electrode mixed material layer of the disclosed secondary-battery negative electrode preferably has a cross-linked structure formed from the water-soluble thickener (A), the cross-linking agent (B), and the particulate polymer (C). Since the cross-linking agent (B) forms a suitable cross-linked structure for making links between molecules of the water-soluble thickener (A), between molecules of the water-soluble thickener (A) and molecules of the particulate polymer (C), and between molecules of the particulate polymer (C), the adherence between a current collector and the negative-electrode mixed material layer can be sufficiently improved and the electrical characteristics of a secondary battery can be also sufficiently improved.

Further, with a view to advantageously solving the above-mentioned problems, the secondary battery of the disclosure comprises any of the above-described secondary-battery negative electrodes, a positive electrode, an electrolysis solution, and a separator. As described, with the use of the above secondary-battery negative electrode, a secondary battery can be obtained that comprises a negative electrode including a negative electrode active material containing a non-carbon-based negative electrode active material, demonstrates superior electrical characteristics, and exhibits superior adherence between a current collector and the negative-electrode mixed material layer.

### Advantageous Effect

According to the slurry composition for a secondary battery negative electrode of the disclosure, even if a negative electrode active material containing a non-carbon-based negative electrode active material is used, a negative-electrode mixed material layer that exhibits superior adherence to a current collector and is capable of improving the electrical characteristics of a secondary battery can be formed.

According to the secondary-battery negative electrode of the disclosure that includes a negative electrode active material containing a non-carbon-based negative electrode active material, the adherence between a current collector and a negative-electrode mixed material layer can be improved and the electrical characteristics of a secondary battery can be also improved.

According to the secondary battery of the disclosure that comprises a secondary-battery negative electrode that includes a negative electrode active material containing a non-carbon-based negative electrode active material, the electrical characteristics can be improved and the adherence between a negative-electrode mixed material layer and a current collector can be ensured.

### DETAILED DESCRIPTION

Hereinafter, embodiments of the disclosure will be described in detail.

The slurry composition for a secondary-battery negative electrode of the disclosure is used to form a secondary-battery negative electrode. The secondary-battery negative electrode of the disclosure can be produced with the slurry composition for a secondary-battery negative electrode of the disclosure. Further, the secondary battery of the disclosure comprises the secondary-battery negative electrode of the disclosure.

(Slurry Composition for Secondary-Battery Negative Electrode)

The slurry composition for a secondary-battery negative electrode of the disclosure includes a water-soluble thickener (A) having a hydroxy group or a carboxyl group, a cross-linking agent (B) having a functional group reactive with the hydroxy group or the carboxyl group of the water-soluble thickener (A), a particulate polymer (C), a negative electrode active material, and water. In the disclosed slurry composition for a secondary-battery negative electrode, the negative electrode active material includes a non-carbon-based negative electrode active material, and the particulate polymer (C) has a functional group reactive with the cross-linking agent (B). The disclosed slurry composition for a secondary-battery negative electrode contains 0.5 mass parts or more but 20 mass parts or less of the water-soluble thickener (A), 0.001 mass parts or more but 10 mass parts or less of the cross-linking agent (B), and 0.5 mass parts or more but 20 mass parts or less of the particulate polymer (C), per 100 mass parts of the negative electrode active material. According to the disclosed slurry composition for a secondary-battery negative electrode, a negative electrode that includes a negative electrode active material containing a non-carbon-based negative electrode active material and thus can increase the capacity of a secondary battery can be formed. Further, according to the disclosed slurry composition for a secondary-battery negative electrode, even if the negative electrode active material containing a non-carbon-based negative electrode active material is used, a negative-electrode mixed material layer that exhibits superior adherence to a current collector and is capable of improving the electrical characteristics of a secondary battery can be formed.

Hereinafter, each component included in the above slurry composition for a secondary-battery negative electrode will be described.

<Water-Soluble Thickener (A)>

The water-soluble thickener (A) having a hydroxy group or a carboxyl group (hereinafter frequently abbreviated as “water-soluble thickener (A)”) serves as a viscosity modifier of a slurry composition. The water-soluble thickener (A) having a hydroxy group or a carboxyl group may be any compound that has at least one of a hydroxy group and a carboxyl group in its molecular structure and can be used as a water-soluble thickener.

In this specification, a thickener can be defined as “water-soluble” when satisfying the following: when a mixture obtained by adding and stirring 1 mass part of thickener (in terms of solid content) into 100 mass parts of deionized water is adjusted to satisfy both of the conditions that the temperature is within a range of 20° C. to 70° C. and the pH is within a range of 3 to 12 (for pH adjustment, NaOH solution and/or HCl solution is used) and is filtered through a 250 mesh screen, the mass of the solid content of the residual left on the screen without passing through the screen does not exceed 50 mass % relative to the solid content of the thickener that has been added. Even if the above mixture of thickener and water when left to stand exhibits emulsion state with separated two phases, the thickener can be identified as water-soluble as long as it satisfies the above definition.

Examples usable as the water-soluble thickener (A) include carboxymethyl cellulose, methyl cellulose, hydroxypropyl methylcellulose, hydroxyethyl methylcellulose, polyvinyl alcohol, polycarboxilic acid, and salts thereof, which may allow good workability when the slurry composition is applied onto a current collector or the like. Examples of the polycarboxilic acid include polyacrylic acid, polymethacrylic acid, and alginic acid. The water-soluble thickener (A) may be used alone or in a combination of two or more thereof in any ratio.

The water-soluble thickener (A) preferably contains carboxymethyl cellulose or a salt thereof (hereinafter frequently abbreviated as “carboxymethyl cellulose (salt)”). When the water-soluble thickener (A) contains carboxymethyl cellulose (salt), better workability can be achieved when the slurry composition is applied onto a current collector or the like.

If carboxymethyl cellulose (salt) is used as the water-soluble thickener (A), the degree of etherification of the carboxymethyl cellulose (salt) used is preferably 0.4 or higher, more preferably 0.7 or higher, but is preferably 1.5 or lower, more preferably 1.0 or lower. With the use of carboxymethyl cellulose (salt) having an etherification degree of 0.4 or higher, good workability can be achieved in applying the slurry composition onto a current collector or the like. If the etherification degree is lower than 0.4, strong hydrogen bonding in and between the molecules of the carboxymethyl cellulose (salt) may cause the water-soluble thickener (A) to turn into a gel-like product, and the thickening effect would be hardly obtained in preparing the slurry composition for a secondary-battery negative electrode, which would deteriorate the workability in preparing the slurry composition for a secondary-battery negative electrode. Further, in applying the obtained slurry composition for a secondary-battery negative electrode onto a current collector and forming a cross-linked structure via the cross-linking agent (B), carboxymethyl cellulose (salt) may become less reactive with the cross-linking agent (B), possibly deteriorating the characteristics of the negative electrode to be obtained. Compared to this, with the use of carboxymethyl cellulose (salt) having an etherification degree of 1.5 or lower, the number of hydroxy groups per molecule of carboxymethyl cellulose (salt) becomes sufficient, thus achieving good reactivity with the cross-linking agent (B) which will be described later. Accordingly, carboxymethyl cellulose (salt) can form a good cross-linked structure via the cross-linking agent (B), and such a cross-linked structure achieves superior cycle characteristics of a secondary battery, which will be described in detail later.

The etherification degree of carboxymethyl cellulose (salt) is the average number of hydroxy group substituted with a substituent such as a carboxymethyl group per unit of one anhydroglucose constituting the carboxymethyl cellulose (salt). The average number may take a value of greater than 0 but less than 3. A greater etherification degree indicates a smaller proportion of the hydroxy group in one molecule of carboxymethyl cellulose (salt) (i.e., indicates a greater proportion of the substituent), and a smaller etherification degree indicates a greater proportion of the hydroxy group in one molecule of carboxymethyl cellulose (salt) (i.e., indicates a smaller proportion of the substituent). This etherification degree (substitution degree) can be obtained by the method described in JP2011-34962A.

The viscosity of 1 mass % aqueous solution of carboxymethyl cellulose (salt) is preferably 500 mPa·s or greater, more preferably 1000 mPa·s or greater, but is preferably 10000 mPa·s or less, more preferably 9000 mPa·s or less. The use of the carboxymethyl cellulose (salt) having a solution viscosity of 500 mPa·s or greater when prepared as a 1 mass % aqueous solution allows the slurry composition to have a moderate viscosity, so that good workability can be achieved when the slurry composition is applied onto a current collector or the like. Further, the use the carboxymethyl cellulose (salt) having a solution viscosity of 10000 mPa·s or less when prepared as a 1 mass % aqueous solution prevents the viscosity of the slurry composition from becoming too high, so that good workability can be achieved when the slurry composition is applied onto a current collector or the like, and the adherence between a negative-electrode mixed material layer obtained with the slurry composition and a current collector can be improved. The viscosity of a 1 mass % aqueous solution of carboxymethyl cellulose (salt) is measured with Brookfield viscometer at 25° C. at 60 rpm.

It is further preferred that the water-soluble thickener (A) contain both of carboxymethyl cellulose (salt) and polycarboxilic acid or a salt thereof (hereinafter frequently abbreviated as “polycarboxilic acid (salt)”). The combined use of carboxymethyl cellulose (salt) and polycarboxilic acid (salt) as the water-soluble thickener (A) would improve the adherence between a negative-electrode mixed material layer obtained with the slurry composition and a current collector and improve the mechanical characteristics, such as strength, of the negative-electrode mixed material layer containing the water-soluble thickener (A). These effects are further followed by the improvement in cycle characteristics or the like of a secondary battery including the above negative electrode. In this regard, the polycarboxilic acid (salt) used in combination with carboxymethyl cellulose (salt) is preferably alginic acid or a salt thereof (hereinafter frequently abbreviated as “alginic acid (salt)”), or polyacrylic acid or a salt thereof (hereinafter frequently abbreviated as “polyacrylic acid (salt)”), among which polyacrylic acid (salt) is particularly preferred. In a word, a water-soluble thickener (A) containing carboxymethyl cellulose or a salt thereof and polyacrylic acid or a salt thereof is particularly preferred. Alginic acid and polyacrylic acid are less likely to swell excessively in the electrolysis solution of a secondary battery as compared with polymethacrylic acid or the like. Thus, as described, by using carboxymethyl cellulose (salt) in combination with alginic acid (salt) or polyacrylic acid (salt), the cycle characteristics and the like of a secondary battery can be sufficiently improved. Further, since polyacrylic acid (salt) has better reactivity with the cross-linking agent (B) than carboxymethyl cellulose (salt), the use of the polyacrylic acid can promote the cross-linked structure-forming reaction via the cross-linking agent (B).

In the disclosed slurry composition for a secondary-battery negative electrode, when the water-soluble thickener (A) contains carboxymethyl cellulose (salt) and polycarboxilic acid (salt), the percentage of the blending amount of the polycarboxilic acid (salt), of the sum of the blending amount of carboxymethyl cellulose (salt) and the blending amount of polycarboxilic acid (salt), is preferably 0.1 mass % or more, more preferably 0.5 mass % or more, particularly preferably 1 mass % or more, but preferably 20 mass % or less, more preferably 10 mass % or less, particularly preferably 5 mass % or less. When the percentage of the blending amount of the polycarboxilic acid (salt), of the sum of the blending amount of the carboxymethyl cellulose (salt) and the blending amount of the polycarboxilic acid (salt), is 0.1 mass % or more, the effects to be provided by the combined use of carboxymethyl cellulose (salt) and polycarboxilic acid (salt) can be sufficiently exerted. Therefore, the adherence between a negative-electrode mixed material layer obtained with the slurry composition and a current collector can be desirably improved. Further, when the percentage of the blending amount of the polycarboxilic acid (salt), of the sum of the blending amount of the carboxymethyl cellulose (salt) and the blending amount of the polycarboxilic acid (salt), is 20 mass % or less, the negative-electrode mixed material layer obtained with the slurry composition would not become too hard, so that the binding capacity between the components contained in the negative-electrode mixed material layer and the ion conductivity can be ensured. Further, the adherence between a negative-electrode mixed material layer obtained with the slurry composition and a current collector can be desirably improved.

The disclosed slurry composition for a secondary-battery negative electrode needs to contain 0.5 mass parts or more but 20 mass parts or less of the water-soluble thickener (A) per 100 mass parts of negative electrode active material, which will be described later. Further, the slurry composition for a secondary-battery negative electrode preferably contains the water-soluble thickener (A) in an amount of 0.7 mass parts or more, more preferably 2 mass parts or more, but preferably 15 mass parts or less, more preferably 10 mass parts or less, further preferably 5 mass parts or less, particularly preferably 3.0 mass parts or less, per 100 mass parts of the negative electrode active material. By setting the blending amount of the water-soluble thickener (A) within the above range, the viscosity of the slurry composition can be made moderate, so that good workability can be achieved in applying the slurry composition onto a current collector or the like. Further, by blending the water-soluble thickener (A) in a proportion of 0.5 mass parts or more per 100 mass parts of the negative electrode active material, the cross-linked structure via the cross-linking agent (B) can be sufficiently formed. Thus, as will be described in detail later, a sufficient number of cross-linked structures can be formed, which achieves superior adherence between a current collector and a negative-electrode mixed material layer in a negative electrode as well as superior cycle characteristics and the like of a secondary battery, while suppressing the expansion of a negative electrode. Also, by blending the water-soluble thickener (A) in a proportion of 20 mass parts or less per 100 mass parts of the negative electrode active material, good mechanical characteristics and ion conductivity can be achieved for the negative-electrode mixed material layer that contains the water-soluble thickener (A), so that superior adherence between a current collector and a negative-electrode mixed material layer in a negative electrode as well as superior rate characteristics and the like of a second battery can be achieved.

<Cross-Linking Agent (B)>

The cross-linking agent (B) having a functional group reactive with the hydroxy group or the carboxyl group of the water-soluble thickener (A) (hereinafter frequently abbreviated as “cross-linking agent (B)”) forms a cross-linked structure with the above-described water-soluble thickener (A) having a hydroxy group or a carboxyl group and with a particulate polymer (C), which will be described later, when for example heated. In other words, it is presumed that the cross-linking agent (B) forms a suitable cross-linked structure that makes links in the water-soluble thickener (A), between the water-soluble thickener (A) and the particulate polymer (C), and in the particulate polymer (C).

Specifically, the water-soluble thickener (A) and the particulate polymer (C) contained in the disclosed slurry composition for a secondary-battery negative electrode form a cross-linked structure via the cross-linking agent (B) when treated for example with heat. As a result, the cross-linking between molecules of the water-soluble thickener (A), between molecules of the water-soluble thickener (A) and molecules of the particulate polymer (C), and between molecules of the particulate polymer (C) provides a cross-linked structure with superior mechanical characteristics, such as elastic modulus, tensile breaking strength, and fatigue resistance, and superior adhesiveness, as well as with low solubility to water (i.e., with superior water resistance). In addition, the formation of the cross-linked structure improves wettability of the negative electrode, formed with the slurry composition, to a electrolysis solution of a secondary battery. The reason is presumed as follows. The water-soluble thickener (A) having a hydroxy group or a carboxyl group has molecular chains that tend to tangle with one another tightly due to the formation of hydrogen bonding or the like, but when the cross-linking reaction occurs, the molecules of the cross-linking agent (B) enter into the tightly-tangled water-soluble thickener (A), which loosens the molecule chains of the water-soluble thickener (A) to provide physical space into which the electrolysis solution can enter.

In view of the foregoing, when the disclosed slurry composition for a secondary-battery negative electrode is used to prepare a secondary-battery negative electrode, good binding can be obtained between the components in the negative-electrode mixed material layer (e.g., negative electrode active material) and the electrical characteristics of a secondary battery including such a negative electrode can be improved. Specifically, when the disclosed slurry composition for a secondary-battery negative electrode is used to prepare a secondary-battery negative electrode, the formation of the cross-linked structure can suppress the expansion of the negative electrode caused by repeated charge and discharge and can ensure high adherence between a negative-electrode mixed material layer and a current collector. Furthermore, the water resistance (low solubility to water) obtained by the formation of the cross-linked structure may allow use of an aqueous slurry composition in forming a porous membrane (e.g., a heat resistant porous membrane formed with alumina particles) and the like on a negative-electrode mixed material layer. Moreover, the cross-linked structure derived from the cross-linking agent (B) improves wettability to an electrolysis solution. This increases the injectability of an electrolysis solution upon formation of a secondary battery using the negative electrode prepared with the disclosed slurry composition for a secondary-battery negative electrode, thus improving electrical characteristics, such as initial coulombic efficiency, cycle characteristics, and initial resistance, and suppressing the resistance increase after cycles.

When the slurry composition does not contain the water-soluble thickener (A) having a hydroxy group or a carboxyl group; that is, when the cross-linked structure is formed only between molecules of the particulate polymer (C), a cross-linked structure that can provide sufficiently good mechanical characteristics, such as elastic modulus, tensile breaking strength, and fatigue resistance, cannot be obtained, thus failing, for example, to suppress the expansion of the negative electrode. Alternatively, when the slurry composition does not contain the particulate polymer (C), which will be described later; that is, when the cross-linked structure is formed only between molecules of the water-soluble thickener (A), the cross-linked structure to be obtained would become excessively rigid, lowering the flexibility of the negative electrode formed with the disclosed slurry composition for a secondary-battery negative electrode, for example. This may lead to deteriorated cycle characteristics.

The disclosed slurry composition for a secondary-battery negative electrode needs to contain 0.001 mass parts or more, preferably contains 0.02 mass parts or more, more preferably 0.05 mass parts or more, and particularly preferably 0.10 mass parts or more of the cross-linking agent (B), per 100 mass parts of the negative electrode active material, which will be described later. The disclosed slurry composition for a secondary-battery negative electrode also needs to contain 10 mass parts or less, preferably contains 0.50 mass parts or less, more preferably 0.30 mass parts or less, and particularly preferably 0.20 mass parts or less of the cross-linking agent (B), per 100 mass parts of the negative electrode active material. When the slurry composition for a secondary-battery negative electrode contains 0.001 mass parts or more of the cross-linking agent (B) per 100 mass parts of the negative electrode active material, a good cross-linked structure can be formed. Thus, when the slurry composition is used to form a negative electrode, it is possible to ensure the adherence between a negative-electrode mixed material layer and a current collector and to ensure the cycle characteristics of a secondary battery. Further, since the cross-linking agent (B) has superior affinity with an electrolysis solution, when the slurry composition contains 0.001 mass parts or more of the cross-linking agent (B) per 100 mass parts of the negative electrode active material, good injectability of an electrolysis solution can be achieved in production of a secondary battery that includes a negative electrode obtained with the slurry composition, whereby electrical characteristics such as rate characteristics and cycle characteristics can be improved. Further, when the slurry composition contains 10 mass parts or less of the cross-linking agent (B) per 100 mass parts of the negative electrode active material, nonuniformity possibly caused in the cross-linked structure can be suppressed; that is, the formation of a local rigid portion which could be an origin of a fracture can be suppressed. Thus, the adherence between a negative-electrode mixed material layer and a current collector can be ensured. Further, inhibition of migration of charge carriers in the negative-electrode mixed material layer due to excessive cross-linking can be restrained, so that electrical characteristics such as initial coulombic efficiency, rate characteristics, and cycle characteristics can be ensured. Electrochemical side reactions caused by impurities derived from a cross-linking agent can be also restrained, whereby cycle characteristics can be ensured.

The disclosed slurry composition for a secondary battery negative electrode contains the cross-linking agent (B) in an amount of preferably 0.001 mass parts or more, more preferably 0.5 mass parts or more, further preferably 1 mass part or more, still further preferably 2 mass parts or more, particularly preferably 3 mass parts or more, most preferably 5 mass parts or more, but preferably less than 100 mass parts, more preferably 90 mass parts or less, further preferably 60 mass parts or less, still further preferably 40 mass parts or less, particularly preferably 15 mass parts or less, most preferably 10 mass parts or less, per 100 mass parts of the water-soluble thickener (A). When the slurry composition for a secondary-battery negative electrode contains 0.001 mass parts or more of the cross-linking agent (B) per 100 mass parts of the water-soluble thickener (A), a good cross-linked structure can be formed. Thus, the slurry composition used to form a negative electrode can ensure the adherence between a negative-electrode mixed material layer and a current collector, and further achieves good injectability of an electrolysis solution in producing a secondary battery including the negative electrode. When the slurry composition for a secondary-battery negative electrode contains less than 100 mass parts of the cross-linking agent (B) per 100 mass parts of the water-soluble thickener (A), nonuniformity in the cross-linked structure can be suppressed, so that the adherence between a negative-electrode mixed material layer and a current collector can be ensured. In addition, the presence of a large amount of (relatively flexible) cross-linking agent (B) would suppress reduction in strength of the negative-electrode mixed material layer. Further, inhibition of charge carrier migration in the negative-electrode mixed material layer, which could be caused due to excessive cross-linking, can be also restrained. Still further, electrochemical side reactions which could be caused due to impurities derived from a cross-linking agent can be also suppressed.

Consequently, when the slurry composition for a secondary-battery negative electrode contains the cross-linking agent (B) in the above range per 100 mass parts of the water-soluble thickener (A), the electrical characteristics of a secondary battery, such as initial coulombic efficiency, rate characteristics, and cycle characteristics, can be ensured, and in addition, an increase in resistance after cycles can be suppressed.

The cross-linking agent (B) can be any compound that has a functional group reactive with the hydroxy group or the carboxyl group of the water-soluble thickener (A). However, it is preferably a compound that preferably has two or more reactive functional groups in one molecule. Here, the reactive functional groups in the cross-linking agent (B) are groups that are reactive with at least one of the hydroxy group and/or carboxyl group in the water-soluble thickener (A) or the functional group reacting with the cross-linking agent (B) in the particulate polymer (C). Examples of such a group include an epoxy group (including a glycidyl group and a glycidyl ether group), an oxazoline group, a carbodiimide group, and a hydroxy group.

Specifically, the cross-linking agent (B) is preferably, for example, a multifunctional epoxy compound having an epoxy group as a reactive functional group, an oxazoline compound having an oxazoline group as a reactive functional group, or a carbodiimide compound having a carbodiimide group as a reactive functional group, among which the carbodiimide compound is further preferred. The use of these compounds, particularly the carbodiimide compound, as the cross-linking agent (B) would ensure the stability of the disclosed slurry composition for a secondary-battery negative electrode to ensure the adherence between a negative-electrode mixed material layer and a current collector, and would also achieve good electrical characteristics of a secondary battery (e.g., initial resistance, cycle characteristics, resistance rise rate, etc.) formed with the slurry composition for a secondary-battery negative electrode.

These compounds may be used alone or in combination of two or more thereof in any ratio.

[Multifunctional Epoxy Compound]

A multifunctional epoxy compound is a compound having two or more epoxy groups in one molecule. Preferred examples of the multifunctional epoxy compound include compounds that have preferably less than six, more preferably less than four, reactive functional groups, described above, in one molecule. With the number of the reactive functional groups in one molecule (the average of the multifunctional epoxy compounds used as the cross-linking agent (B)) being within the above range, the ingredients of the slurry composition can be prevented from being cohered to sink. This can ensure the stability of the slurry composition.

Preferred examples of the multifunctional epoxy compound include multifunctional glycidyl ether compounds, such as aliphatic polyglycidyl ether, aromatic polyglycidyl ether, and diglycidyl ether. The multifunctional glycidyl ether compound having two or more glycidyl ether groups in one molecule have particularly superior affinity with an electrolysis solution, thereby particularly improving the injectability of an electrolysis solution upon production of a secondary battery when used as the cross-linking agent (B).

[Oxazoline Compound]

The oxazoline compound can be any cross-linkable compound that has an oxazoline group in its molecule and can form a cross-linked structure between molecules of the water-soluble thickener (A), between molecules of the water-soluble thickener (A) and molecules of the particulate polymer (C), and between molecules of the particulate polymer (C). Preferred oxazoline compounds may be compounds that have two or more oxazoline groups in the molecule. Note that some or all of the hydrogen atoms of the oxazoline group may be substituted with other groups. Examples of such a compound having two or more oxazoline groups in the molecule include a compound having two oxazoline groups in one molecule (divalent oxazoline compound) and a polymer containing an oxazoline group (oxazoline group-containing polymer).

[[Divalent Oxazoline Compound]]

Examples of the divalent oxazoline compound include 2,2′-bis(2-oxazoline), 2,2′-bis(4-methyl-2-oxazoline), 2,2′-bis(4,4-dimethyl-2-oxazoline), 2,2′-bis(4-ethyl-2-oxazoline), 2,2′-bis(4,4′-diethyl-2-oxazoline), 2,2′-bis(4-propyl-2-oxazoline), 2,2′-bis(4-butyl-2-oxazoline), 2,2′-bis(4-hexyl-2-oxazoline), 2,2′-bis(4-phenyl-2-oxazoline), 2,2′-bis(4-cyclohexyl-2-oxazoline), and 2,2′-bis(4-benzyl-2-oxazoline). Of these, 2,2′-bis(2-oxazoline) is preferred to form more rigid cross-linked structure.

[[Oxazoline Group-Containing Polymer]]

The oxazoline group-containing polymer may be any polymer that contains an oxazoline group. In this specification, the above-mentioned divalent oxazoline compounds are not included in the oxazoline group-containing polymer.

The oxazoline group-containing polymer can be synthesized for example by copolymerizing the oxazoline group-containing monomer given by the following general formula (I) and other monomers.

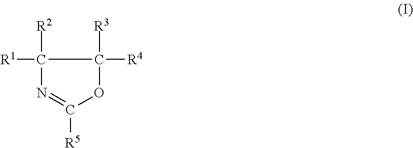

(In the formula, R¹, R², R³, and R⁴ each independently represent a hydrogen atom, a halogen atom, an alkyl group, an aryl group optionally having a substituent, or an aralkyl group optionally having a substituent, and R⁵ represents an acyclic organic group having an addition-polymerizable unsaturated bond.)

The halogen atom in the general formula (I) may be, for example, a fluorine atom, a chlorine atom, a bromine atom, or an iodine atom. Of these, the fluorine atom and the chlorine atom are preferred.

The alkyl group in the general formula (I) may be, for example, an alkyl group having a carbon number of 1 to 8. Of these, an alkyl group having a carbon number of 1 to 4 is preferred.

The aryl group optionally having a substituent in the general formula (I) is, for example, an aryl group optionally having a substituent such as a halogen atom. The aryl group may be, for example an aryl group having a carbon number of 6 to 18, such as a phenyl group, a tolyl group, a xylyl group, a biphenyl group, a naphthyl group, an anthryl group, and a phenanthryl group. A preferred aryl group optionally having a substituent is an aryl group having a carbon number of 6 to 12 and optionally a substituent.

The aralkyl group optionally having a substituent in the general formula (I) may be, for example, an aralkyl group optionally having a substituent such as a halogen atom. The aralkyl group may be, for example, an aralkyl group having a carbon number of 7 to 18, such as a benzyl group, a phenylethyl group, a methylbenzyl group, and a naphthylmethyl group. A preferred aralkyl group optionally having a substituent is an aralkyl group having a carbon number of 7 to 12 and optionally a substituent.

The acyclic organic group having an addition-polymerizable unsaturated bond in the general formula (I) may be, for example, an alkenyl group having a carbon number of 2 to 8, such as a vinyl group, an allyl group, and an isopropenyl group. Of these, a vinyl group, an allyl group, and an isopropenyl group are preferred.

Examples of the oxazoline group-containing monomer given by the general formula (I) include 2-vinyl-2-oxazoline, 2-vinyl-4-methyl-2-oxazoline, 2-vinyl-4-ethyl-2-oxazoline, 2-vinyl-4-propyl-2-oxazoline, 2-vinyl-4-butyl-2-oxazoline, 2-vinyl-5-methyl-2-oxazoline, 2-vinyl-5-ethyl-2-oxazoline, 2-vinyl-5-propyl-2-oxazoline, 2-vinyl-5-butyl-2-oxazoline, 2-isopropenyl-2-oxazoline, 2-isopropenyl-4-methyl-2-oxazoline, 2-isopropenyl-4-ethyl-2-oxazoline, 2-isopropenyl-4-propyl-2-oxazoline, 2-isopropenyl-4-butyl-2-oxazoline, 2-isopropenyl-5-methyl-2-oxazoline, 2-isopropenyl-5-ethyl-2-oxazoline, 2-isopropenyl-5-propyl-2-oxazoline, and 2-isopropenyl-5-butyl-2-oxazoline. Of these, 2-isopropenyl-2-oxazoline is preferred for its industrially ready availability. These oxazoline group-containing monomers may be used alone or in combination of two or more thereof in any ratio.

The above-mentioned another monomer that may be used for the synthesis of the oxazoline group-containing polymer may be any copolymerizable monomer known in the art. Suitable examples thereof include a (meth)acrylic acid monomer, a (meth)acrylic acid ester monomer, and an aromatic monomer. The term “(meth)acrylic” as used herein means “acrylic” and/or “methacrylic”.

Examples of the (meth)acrylic acid monomer usable for the synthesis of the oxazoline group-containing polymer include acrylic acid, methacrylic acid, acrylate such as sodium acrylic acid and ammonium acrylic acid, and methacrylate such as sodium methacrylic acid and ammonium methacrylic acid. These (meth)acrylic acid monomers may be used alone or in combination of two or more thereof in any ratio.

Examples of the (meth)acrylic acid ester monomer usable for the synthesis of the oxazoline group-containing polymer include acrylic acid esters, such as methyl acrylate, ethyl acrylate, butyl acrylate, 2-ethylhexyl acrylate, stearyl acrylate, perfluoroalkylethyl acrylate, phenyl acrylate, 2-hydroxyethyl acrylate, 2-aminoethyl acrylate and its salt, acrylic acid methoxy polyethylene glycol, and a monoesterified product of acrylic acid and polyethylene glycol; and methacrylic acid esters, such as methyl methacrylate, butyl methacrylate, 2-ethylhexyl methacrylate, 2-hydroxyethyl methacrylate, methoxy polyethylene glycol methacrylate, monoesterified product of methacrylic acid and polyethylene glycol, and 2-aminoethyl methacrylate and its salt. These (meth)acrylic acid ester monomers may be used alone or in combination of two or more thereof in any ratio.

Examples of the aromatic monomer usable for the synthesis of the oxazoline group-containing polymer include styrene compounds, such as styrene, α-methyl styrene, and sodium styrenesulfonate. These aromatic monomers may be used alone or in combination of two or more thereof in any ratio.

By polymerizing these monomers using them in the ratio described for example in JP2013-72002A or Japanese Patent No. 2644161 and using the method described in these documents, an oxazoline group-containing polymer can be synthesized. Alternatively, the oxazoline group-containing polymer may be synthesized for example by polymerizing polymers without any oxazoline group, and then substituting oxazoline groups for some or all of the functional groups of the polymer.

If the above-mentioned oxazoline group-containing polymer is used as the cross-linking agent (B), the glass-transition temperature (Tg) of the oxazoline group-containing polymer is preferably −50° C. or higher, more preferably −20° C. or higher, but preferably 60° C. or lower, more preferably 30° C. or lower.

The “glass-transition temperature” of the oxazoline group-containing polymer can be measured in accordance with the method used for the measurement of the glass transition temperature of the particulate polymer (C) described in the example section of the specification.

If the above-mentioned oxazoline compound is used as the cross-linking agent (B), the chemical formula weight of the oxazoline compound per mole of oxazoline group (oxazoline equivalent) is preferably 70 or more, more preferably 100 or more, further preferably 300 or more, but preferably 600 or less, more preferably 500 or less. This oxazoline equivalent may also be called an oxazoline valence (mass per mole of oxazoline group (g-solid/eq.)). With the oxazoline equivalent of the oxazoline compound being 70 or more, the disclosed slurry composition for a secondary-battery negative electrode can sufficiently ensure its preservation stability. With that 600 or less, the oxazoline compound can promote good cross-linking reaction as a cross-linking agent.

The oxazoline equivalent of the oxazoline compound can be calculated by the following expression:

Oxazoline equivalent=(molecular weight of oxazoline compound)/(number of oxazoline group per molecule of oxazoline compound)

In this regard, when the oxazoline compound is the oxazoline group-containing polymer, the molecular weight of the oxazoline compound can be specified, for example, as a polystyrene-converted number-average molecular weight measured with GPC (gel permeation chromatography), and the number of oxazoline groups per molecule of oxazoline compound can be quantified for example with IR (infrared spectroscopy).

[Carbodiimide Compound]

The carbodiimide compound may be any cross-linkable compound that has a carbodiimide group represented by the general formula (1): —N═C═N— (1) in the molecule and can form a cross-linked structure between molecules of the water-soluble thickener (A), between molecules of the water-soluble thickener (A) and molecules of the particulate polymer (C), and between molecules of the particulate polymer (C). One specific suitable example of the cross-linking agent (B) having such a carbodiimide group may be a compound having two or more carbodiimide groups, or specifically polycarbodiimide having repeat units represented by the general formula (2): —N═C═N—R′ (2) (where R¹ indicates a divalent organic group) and/or modified polycarbodiimide. The modified polycarbodiimide herein refers to resin obtained by reacting a reactive compound, which will be described later, with polycarbodiimide.

[[Synthesis of Polycarbodiimide]]

Polycarbodiimide may be synthesized by any method. For example, polycarbodiimide may be synthesized by reacting organic polyisocyanate in the presence of a catalyst that promotes carbodiimidization reaction of the isocyanate groups (hereinafter referred to as “carbodiimidization catalyst”). The polycarbodiimide having the repeat units represented by the general formula (2) may also be synthesized by copolymerizing an oligomer obtained by reacting organic polyisocyanate (carbodiimide oligomer) with a monomer copolymerizable with the oligomer.

A preferred organic polyisocyanate used for the synthesis of the polycarbodiimide is organic diisocyanate.

Examples of the organic diisocyanate used for the synthesis of the polycarbodiimide include those described in JP2005-49370A. Of these, 2,4-tolylene diisocyanate and 2,6-tolylene diisocyanate are particularly preferred, considering the preservation stability of the slurry composition containing polycarbodiimide as the cross-linking agent (B). The organic diisocyanate may be used alone or in combination of two or more thereof in any ratio.

In combination with the above-described organic diisocyanate, an organic polyisocyanate having three or more isocyanate groups (tri- or more functional organic polyisocyanate) or a terminal isocyanate prepolymer obtained by reacting stoichiometric excessive amounts of tri- or more functional organic polyisocyanate with a multifunctional active hydrogen-containing compound having di- or more functionalities may be used. Hereinafter, the tri- or more functional organic polyisocyanate and the terminal isocyanate prepolymer are collectively referred to as “tri- or more functional organic polyisocyanates”. Examples of such tri- or more functional organic polyisocyanates include those described for example in JP2005-49370A. The tri- or more functional organic polyisocyanates may be used alone or in combination of two or more thereof in any ratio. The amount of the tri- or more functional organic polyisocyanates used in the synthesis reaction of polycarbodiimide is usually 40 mass parts or less, preferably 20 mass parts or less per 100 mass parts of the organic diisocyanate.

Further, in synthesizing polycarbodiimide, organic monoisocyanate may be added as necessary. By adding organic monoisocyanate, when the organic polyisocyanate contains tri- or more functional organic polyisocyanates, the molecular weight of the polycarbodiimide to be obtained can be regulated appropriately. Further, by using organic diisocyanate in combination with organic monoisocyanate, the polycarbodiimide to be obtained will have relatively low molecular weight. Examples of such organic monoisocyanate include those described in JP2005-49370A. The organic monoisocyanate may be used alone or in combination of two or more thereof in any ratio. The amount of the organic monoisocyanate used in the synthesis reaction of polycarbodiimide is usually 40 mass parts or less, preferably 20 mass parts or less, per 100 mass parts of the total organic polyisocyanate component (organic diisocyanate and tri- or more functional organic polyisocyanates), although the amount changes depending for example on the molecular weight required for the polycarbodiimide to be obtained and whether any tri- or more functional organic polyisocyanates are used.

Examples of the carbodiimidization catalyst include phospholene compounds, metal carbonyl complexes, metal acetylacetone complexes, and phosphoric acid ester. Specific examples of each of them are given for example in JP2005-49370A. The carbodiimidization catalyst may be used alone or in combination of two or more thereof in any ratio. The amount of the carbodiimidization catalyst used is usually 0.001 mass parts or more, preferably 0.01 mass parts or more, but usually 30 mass parts or less, preferably 10 mass parts or less, per 100 mass parts of the total organic isocyanate component (organic monoisocyanate, organic diisocyanate, and tri- or more functional organic polyisocyanates).

The carbodiimidization reaction of the organic polyisocyanate can be carried out without solvent or in a suitable solvent. When the synthesis reaction is carried out in a solvent, any solvent that can dissolve the polycarbodiimide or the carbodiimide oligomer to be formed through heating during the synthesis reaction can be used. Examples of such a solvent include halogenated hydrocarbon solvents, ether solvents, ketone solvents, aromatic hydrocarbon solvents, amide solvents, aprotic polar solvents, and acetate solvents. Specific examples of each of them are given for example in JP2005-49370A. These solvents may be used alone or in combination of two or more thereof in any ratio. The amount of the solvent used in the synthesis reaction of polycarbodiimide is such an amount that allows the concentration of the total organic isocyanate component to become usually 0.5 mass % or higher, preferably 5 mass % or higher, but usually 60 mass % or lower, preferably 50 mass % or lower. If the concentration of the total organic isocyanate component in the solvent is too high, the polycarbodiimide or the carbodiimide oligomer to be formed may gelate during the synthesis reaction. On the other hand, if the concentration of the total organic isocyanate component in the solvent is too low, the reaction rate is decreased and productivity is declined.

The temperature at which the carbodiimidization reaction of the organic polyisocyanate is performed is appropriately selected depending on the kind of organic isocyanate component and the kind of carbodiimidization catalyst. However, the temperature is usually 20° C. or higher but 200° C. or lower. In the carbodiimidization reaction of the organic polyisocyanate, the total amount of the organic isocyanate component may be added before the reaction. Alternatively, part or all of the organic isocyanate component may be added during the reaction continuously or stepwise. Further, a compound reactive with an isocyanate group may be added at any suitable reaction stage from the initial stage to later stage of the carbodiimidization of the organic polyisocyanate to seal the terminal isocyanate group of the polycarbodiimide, which allows adjustment of the molecular weight of the polycarbodiimide to be obtained. Alternatively, the compound reactive with an isocyanate group may be added at a later stage of the carbodiimidization reaction of the organic polyisocyanate to regulate the molecular weight of the polycarbodiimide to be obtained to a predetermined value. Examples of such a compound reactive with an isocyanate group include alcohols such as methanol, ethanol, i-propanol, and cyclohexanol; and amines such as dimethylamine, diethylamine, and benzylamine.

Preferred examples of the monomer copolymerizable with the carbodiimide oligomer include di- or more valent alcohol, and an oligomer obtained by using di- or more valent alcohol as a monomer and esters thereof. Preferred examples of the di- or more valent alcohol include divalent alcohols such as ethylene glycol and propylene glycol; and preferred examples of the oligomer obtained by using di- or more valent alcohol as a monomer and esters thereof includes polyalkylene oxide, polyethylene glycol monomethacrylate, polypropylene glycol monomethacrylate, polyethylene glycol monoacrylate, and polypropylene glycol monoacrylate.

For example, by copolymerizing divalent alcohol having a hydroxyl group at each terminal of the molecular chain and the carbodiimide oligomer using a conventional method, a polycarbodiimide having a polycarbodiimide group and a divalent alcohol-derived monomer unit can be synthesized. As described, when the polycarbodiimide as the cross-linking agent (B) has a di- or more valent alcohol-derived monomer unit, preferably a divalent alcohol-derived monomer unit, the wettability of the negative electrode, formed from the slurry composition containing the polycarbodiimide, to an electrolysis solution can be improved, so that the injectability of an electrolysis solution can be improved in producing a secondary battery including the negative electrode. Further, by copolymerizing the above-described alcohols, the water solubility of the polycarbodiimide can be increased and the polycarbodiimide self-assembles into micelles in water (or the hydrophobic carbodiimide group is covered around with hydrophile ethylene glycol chains), which can thus improve chemical stability.

The above-described polycarbodiimide is used for the preparation of the disclosed slurry composition for a secondary-battery negative electrode in the form of solution or in the form of solid separated from the solution. The polycarbodiimide may be separated and collected from the solution for example by adding the polycarbodiimide solution to a non-solvent inactive to the polycarbodiimide, and filtering or decanting the resulting precipitation or oil matter; by spray drying the polycarbodiimide solution; or by utilizing the temperature-caused solubility change with respect to the solvent used in the synthesis of the polycarbodiimide, that is, by decreasing the temperature of the system to precipitate the polycarbodiimide, which had been dissolved in the solvent immediately after the synthesis, and for example filtering the turbid solution. These separation and collection methods may also be used in any combination. The number-average molecular weight (hereinafter referred to as “Mn”) of the disclosed polycarbodiimide in terms of polystyrene obtained by gel permeation chromatography (GPC) is usually 400 or more, preferably 1,000 or more, particularly preferably 2,000 or more, but usually 500,000 or less, preferably 200,000 or less, particularly preferably 100,000 or less.

[[Synthesis of Modified Polycarbodiimide]]

Next, a method of synthesizing modified polycarbodiimide is described. The modified polycarbodiimide can be synthesized by reacting at least one reactive compound with at least one polycarbodiimide having the repeat unit represented by the general formula (2) in the presence or absence of a suitable catalyst at a suitable temperature (hereinafter referred to as “modification reaction”).

The reactive compound used in the synthesis of the modified polycarbodiimide is a compound having one group reactive with polycarbodiimide (hereinafter simply referred to as “reactive group”) and other functional groups in its molecule. The reactive compound may be an aromatic compound, an aliphatic compound, or an alicyclic compound. The ring structure of the aromatic compound and the alicyclic compound may be carbocyclic or heterocyclic. The reactive group in the reactive compound can be any group that has active hydrogen, such as a carboxyl group, and a primary or secondary amino group. As mentioned, the reactive compound has other functional groups in addition to the one reactive group in its molecule. Such other functional groups in the reactive compound may be, for example, groups that function to promote the cross-linking reaction of polycarbodiimide and/or modified polycarbodiimide, or second and subsequent groups (i.e., different groups from the above-mentioned one reactive group), in one molecule of the reactive compound, having the above-mentioned active hydrogen, such as the carboxyl group and the primary or secondary amino group mentioned above as the group having active hydrogen, as well as a carboxylic acid anhydride group and a tertiary amino group. Two or more identical or different other functional groups can exist in one molecule of the reactive compound.

Examples of the reactive compound include those described in JP2005-49370A. Of the reactive compounds, trimellitic anhydride and nicotinic acid are preferred. The reactive compounds may be used alone or in combination of two or more thereof in any ratio.

The amount of the reactive compound used in the modification reaction for synthesizing the modified polycarbodiimide is appropriately adjusted according to, for example, the kind of polycarbodiimide or the reactive compound, and the physical properties required for the modified polycarbodiimide to be obtained. However, the amount is adjusted such that the proportion of the reactive group in the reactive compound relative to 1 mole of the repeat unit represented by the general formula (2) of polycarbodiimide becomes preferably 0.01 moles or more, further preferably 0.02 moles or more, but preferably 1 mole or less, further preferably 0.8 moles or less. When the above proportion is less than 0.01 moles, the preservation stability of the slurry composition containing the modified polycarbodiimide may be decreased. Conversely, if the above proportion exceeds 1 mole, the intrinsic properties of polycarbodiimide may be impaired.

In the modification reaction, reaction of the reactive group in the reactive compound with the repeat unit represented by the general formula (2) of polycarbodiimide proceeds quantitatively, and functional groups that correspond to the used amount of the reactive compound are introduced into the modified polycarbodiimide. The modification reaction can be carried out without any solvent; however, it is preferably carried out in an appropriate solvent. Such a solvent may be any solvent that is inactive to polycarbodiimide and the reactive compound and can dissolve them. Examples of the solvent include ether solvents, amide solvents, ketone solvents, aromatic hydrocarbon solvents, and aprotic polar solvent usable for the above-described synthesis of the polycarbodiimide. These solvents may be used alone or in combination of two or more thereof in any ratio. When the solvent used in the synthesis of the polycarbodiimide can be used for the modification reaction, the polycarbodiimide solution obtained by the synthesis can be directly used. The amount of the solvent used in the modification reaction is usually 10 mass parts or more, preferably 50 mass parts or more, but usually 10,000 mass parts or less, preferably 5,000 mass parts or less, per 100 mass parts of the total reaction raw material. The temperature of the modification reaction is appropriately selected depending on the kind of polycarbodiimide or the reactive compound; however, it is usually −10° C. or higher, but usually 100° C. or lower, preferably 80° C. or lower. Mn of the disclosed modified polycarbodiimide is usually 500 or more, preferably 1,000 or more, further preferably 2,000 or more, but usually 1,000,000 or less, preferably 400,000 or less, further preferably 200,000 or less.

When the above-described carbodiimide compound is used as the cross-linking agent (B), the chemical formula weight of the carbodiimide compound per mole of carbodiimide group (—N═C═N—) (NCN equivalent) is preferably 300 or more, more preferably 400 or more, but preferably 600 or less, more preferably 500 or less. With the NCN equivalent of the cross-linking agent (B) being 300 or more, the preservation stability of the disclosed slurry composition for a secondary-battery negative electrode can be sufficiently ensured. With that being 600 or less, the cross-linking agent (B) can promote good cross-linking reaction as a cross-linking agent.

In this regard, the NCN equivalent of the carbodiimide compound can be calculated for example with the expression below by obtaining the polystyrene-converted number-average molecular weight of the carbodiimide compound using GPC (gel permeation chromatography) and by performing quantitative analysis of the number of the carbodiimide group per mole of the carbodiimide compound using IR (infrared spectroscopy).

NCN equivalent=(polystyrene-converted number-average molecular weight of carbodiimide compound)/(number of carbodiimide group per molecule of carbodiimide compound)

[Properties Etc. of Cross-Linking Agent (B)]

The viscosity of a 1 mass % aqueous solution of the above-described cross-linking agent (B) is preferably 5000 mPa·s or lower, more preferably 700 mPa·s or lower, and particularly preferably 150 mPa·s or lower. By using the cross-linking agent that gives a solution viscosity within the above range when prepared as a 1 mass % aqueous solution, superior adherence between a negative-electrode mixed material layer and a current collector can be achieved. The viscosity of a 1 mass % aqueous solution of the cross-linking agent (B) can be measured by the same method as that used for measuring the viscosity of a 1 mass % aqueous solution of the above-described carboxymethyl cellulose (salt).

The cross-linking agent (B) is preferably water-soluble. With the cross-linking agent (B) being water-soluble, the cross-linking agent (B) can be prevented from being unevenly distributed in an aqueous slurry composition, so that the negative-electrode mixed material layer to be obtained can form a suitable cross-linked structure. This can accordingly ensure the adherence strength between the negative-electrode mixed material layer and the current collector in the secondary battery to be obtained, and can improve the electrical characteristics, such as initial coulombic efficiency, initial resistance, and cycle characteristics, which can further suppress the resistance increase after cycles. Moreover, the water resistance of the negative electrode can be improved.

In this specification, a cross-linking agent (B) can be defined as “water-soluble” when satisfying the following: when a mixture obtained by adding and stirring 1 mass part of cross-linking agent (in terms of solid content) into 100 mass parts of deionized water is adjusted to satisfy both of the conditions that the temperature is within a range of 20° C. to 70° C. and the pH is within a range of 3 to 12 (for pH adjustment, NaOH solution and/or HCl solution is used) and is filtered through a 250 mesh screen, the mass of the solid content of the residual left on the screen without passing through the screen does not exceed 50 mass % relative to the solid content of the cross-linking agent that has been added. Even if the above mixture of the cross-linking agent and water when left to stand exhibits emulsion state with separated two phases, the cross-linking agent can be identified as water-soluble as long as it satisfies the above definition. To promote good cross-linked structure-forming reaction and improve the adherence strength between the negative-electrode mixed material layer and the current collector as well as cycle characteristics, it is more preferred that the above mixture of the cross-linking agent and water does not separate into two phases (i.e., the mixture being in the form of one-phase water solution); that is, it is more preferred that the cross-linking agent be a one-phase aqueous solution when dissolved in water.

The water solubility of the cross-linking agent (B) is preferably 80 mass % or more and more preferably 90 mass % or more, for the same reason as the reason given above for the cross-linking agent being preferably water-soluble. The “water solubility” of the cross-linking agent (B) is defined by the following expression when a mixture obtained by adding and stirring 1 mass part of cross-linking agent (in terms of solid content) into 100 mass parts of deionized water is adjusted to 25° C. and pH 7, passed through a 250 mesh screen, and the percentage of the mass of the solid content of the residue left on the screen without passing through the screen with respect to the mass of the solid content of the cross-linking agent being added is defined as X mass %.

Water solubility=(100−X)mass %

<Particulate Polymer (C)>

The particulate polymer (C) having a functional group reactive with the cross-linking agent (B) (hereinafter frequently abbreviated as “particulate polymer (C)”) is a component that can retain the components contained in a negative electrode (e.g., negative electrode active material) from desorbing from the negative electrode produced with the disclosed slurry composition for a secondary-battery negative electrode. When the negative-electrode mixed material layer is formed with the slurry composition, the particulate polymer in the negative-electrode mixed material layer, when immersed in an electrolysis solution, generally absorbs the electrolysis solution to swell but maintains the particulate shape and binds the negative electrode active materials to prevent the negative electrode active material from coming off the current collector. The particulate polymer even binds the particles other than the negative electrode active material contained in the negative-electrode mixed material layer and serves to maintain the strength of the negative-electrode mixed material layer.

The phrase “containing a monomer unit” as used herein means that “a polymer obtained using the monomer includes a structural unit derived from the monomer”.

The particulate polymer (C) used herein has a functional group reactive with the functional group of the cross-linking agent (B) (e.g., epoxy group, oxazoline group, carbodiimide group, etc.). The particulate polymer (C) having the functional group reactive with the cross-linking agent (B) enables the cross-linking between molecules of the particulate polymer (C) and between molecules of the water-soluble thickener (A) and molecules of the particulate polymer (C) via the cross-linking agent (B).

Examples usable as the particulate polymer (C) include known polymers having functional groups reactive with the functional group of the cross-linking agent (B), for example, diene polymers, acrylic polymers, fluoropolymers, and silicon polymers, among which copolymers having an aliphatic conjugated diene monomer unit and an aromatic vinyl monomer unit are preferred. Such copolymers have an aliphatic conjugated diene monomer unit that are flexible repeat units with low rigidity and capable of increasing binding capacity, and an aromatic vinyl monomer unit capable of decreasing the solubility of the polymer to an electrolysis solution to increase the stability of the particulate polymer in the electrolysis solution. The copolymers can thus serve as the particulate polymer (C) desirably. The above-mentioned polymers may be used alone or in combination of two or more thereof in any ratio.

Examples of the functional group reactive with the cross-linking agent (B) in the particulate polymer (C) include a carboxyl group, a hydroxy group, a glycidyl ether group, and a thiol group. Of these, considering the electrical characteristics such as cycle characteristics of the secondary battery obtained with the disclosed slurry composition for a secondary-battery negative electrode, the particulate polymer (C) preferably has one or more of a carboxyl group, a hydroxy group, and a thiol group, and further preferably has at least one of a carboxyl group and a hydroxy group. In addition, it is particularly preferred that the particulate polymer (C) have both of a carboxyl group and a hydroxy group to concurrently achieve electrical characteristics, such as cycle characteristics, and suppression of the expansion of a negative electrode caused by discharge and charge.

The “particulate polymer” is a polymer dispersible into an aqueous medium such as water, which exists in an aqueous medium in the form of particulates. When 0.5 g of particulate polymer is dissolved in 100 g of water at 25° C., in general, 90 mass % or more of the particulate polymer would remain as an insoluble matter.

The disclosed slurry composition for a secondary-battery negative electrode needs to contain 0.5 mass parts or more, preferably contains 0.8 mass parts or more, more preferably 1.0 mass part or more of the particulate polymer (C), per 100 mass parts of the negative electrode active material, which will be described later. The disclosed slurry composition for a secondary-battery negative electrode also needs to contain 20 mass parts or less, preferably contains 5 mass parts or less, more preferably 2 mass parts or less of the particulate polymer (C), per 100 mass parts of the negative electrode active material. When the slurry composition for a secondary-battery negative electrode contains 0.5 mass parts or more of the particulate polymer (C) per 100 mass parts of the negative electrode active material, a good cross-linked structure can be formed and binding capacity can be ensured. This can accordingly ensure the strength of the negative-electrode mixed material layer obtained with the slurry composition, so that the expansion of the negative electrode can be sufficiently suppressed. Further, the adherence can be ensured between a negative-electrode mixed material layer and a current collector. On the other hand, when the slurry composition for a secondary-battery negative electrode contains 20 mass parts or less of the particulate polymer (C) per 100 mass parts of the negative electrode active material, the injectability of an electrolysis solution can be ensured, and further, electrical characteristics such as rate characteristics can be ensured. Moreover, impurities, such as emulsifier remaining in the particulate polymer (C), can be prevented from mixing into an electrolysis solution. This consequently prevents degradation of electrical characteristics such as cycle characteristics.

The disclosed slurry composition for a secondary-battery negative electrode preferably contains the particulate polymer (C) in an amount of 10 mass parts or more, more preferably 30 mass parts or more, further preferably 50 mass parts or more, but preferably less than 500 mass parts, more preferably 300 mass parts or less, further preferably 200 mass parts or less, per 100 mass parts of the water-soluble thickener (A). When the slurry composition for a secondary-battery negative electrode contains 10 mass parts or more of the particulate polymer (C) per 100 mass parts of the water-soluble thickener (A), a good cross-linked structure can be formed and binding capacity can be ensured. This can accordingly ensure the strength of the negative-electrode mixed material layer obtained with the slurry composition, so that the expansion of the negative electrode can be sufficiently suppressed. Further, the adherence between a negative-electrode mixed material layer and a current collector can be ensured. On the other hand, when the slurry composition for a secondary-battery negative electrode contains less than 500 mass parts of the particulate polymer (C) per 100 mass parts of the water-soluble thickener (A), the injectability of an electrolysis solution can be ensured, and further, an increase in the initial resistance of the negative electrode can be suppressed. Moreover, impurities, such as emulsifier remaining in the particulate polymer (C), can be prevented from mixing into an electrolysis solution. This consequently prevents degradation of electrical characteristics such as cycle characteristics.

[Monomers Used in Preparation of Copolymer Having Aliphatic Conjugated Diene Monomer Unit and Aromatic Vinyl Monomer Unit]

When a copolymer having an aliphatic conjugated diene monomer unit and an aromatic vinyl monomer unit is used as the particulate polymer (C), the aliphatic conjugated diene monomer that can form the aliphatic conjugated diene monomer unit may be, but is not limited to, 1,3-butadiene, 2-methyl-1,3-butadiene, 2,3-dimethyl-1,3-butadiene, 2-chloro-1,3-butadiene, substituted linear conjugated pentadienes, or substituted and side-chain conjugated hexadienes. Of these, 1,3-butadiene is preferred. The aliphatic conjugated diene monomer may be used alone or in combination of two or more thereof in any ratio.

The content percentage of the aliphatic conjugated diene monomer units in the particulate polymer (C) is preferably 20 mass % or more, more preferably 30 mass % or more, but preferably 70 mass % or less, more preferably 60 mass % or less, particularly preferably 55 mass % or less. With the content percentage of the aliphatic conjugated diene monomer unit being 20 mass % or more, the flexibility of the negative electrode can be increased. On the other hand, with the content percentage being 70 mass % or less, good adherence can be achieved between a negative-electrode mixed material layer and a current collector, and the negative electrode obtained with the disclosed slurry composition for a secondary-battery negative electrode can have improved electrolysis-solution resistance.

Examples of the aromatic vinyl monomer that can form the aromatic vinyl monomer unit of the particulate polymer (C) include, but not limited to, styrene, α-methylstyrene, vinyltoluene, and divinyl benzene. Of these, styrene is preferred. The aromatic vinyl monomer may be used alone or in combination of two or more thereof in any ratio.

The content percentage of the aromatic vinyl monomer unit in the particulate polymer (C) is preferably 30 mass % or more, more preferably 35 mass % or more, but preferably 79.5 mass % or less, more preferably 69 mass % or less. With the content percentage of the aromatic vinyl monomer unit being 30 mass % or more, the negative electrode obtained with the disclosed slurry composition for a secondary-battery negative electrode can have improved electrolysis-solution resistance. On the other hand, with the content percentage being 79.5 mass % or less, good adherence can be achieved between a negative-electrode mixed material layer and a current collector.

The particulate polymer (C) preferably contains a 1,3-butadiene unit as the aliphatic conjugated diene monomer unit and a styrene unit as the aromatic vinyl monomer unit; that is, the particulate polymer (C) is preferably a styrene-butadiene copolymer.

In this regard, the particulate polymer (C) needs to have a functional group reactive with the cross-linking agent (B). In other words, the particulate polymer (C) needs to have a monomer unit that contains a functional group reactive with the cross-linking agent (B). Examples of the monomer unit containing the functional group reactive with the cross-linking agent (B) include a monomer unit of ethylenic unsaturated carboxylic acid, an unsaturated monomer unit having a hydroxy group, an unsaturated monomer unit having a glycidyl ether group, and a monomer unit having a thiol group.

Examples of the ethylenic unsaturated carboxylic acid monomer usable in producing the particulate polymer (C) having a carboxylic acid group as the functional group reactive with the cross-linking agent (B) include monocarboxylic acids and dicarboxylic acids, such as acrylic acid, methacrylic acid, crotonic acid, maleic acid, fumaric acid, and itaconic acid; and anhydrides thereof. Of these, considering the stability of the disclosed slurry composition for a secondary-battery negative electrode, preferred examples of the ethylenic unsaturated carboxylic acid monomer are acrylic acid, methacrylic acid, and itaconic acid. These may be used alone or in combination of two or more thereof in any ratio.

Examples of the unsaturated monomer having a hydroxy group usable in producing the particulate polymer (C) having a hydroxy group as the functional group reactive with the cross-linking agent (B) include 2-hydroxyethyl acrylate, 2-hydroxyethyl methacrylate, hydroxypropyl acrylate, hydroxypropyl methacrylate, hydroxybutyl acrylate, hydroxybutyl methacrylate, 3-chloro-2-hydroxypropyl methacrylate, di-(ethylene glycol)maleate, di-(ethylene glycol)itaconate, 2-hydroxyethyl maleate, bis(2-hydroxyethyl)maleate, and 2-hydroxyethyl methyl fumarate. Of these, 2-hydroxyethyl acrylate is preferred. These may be used alone or in combination of two or more thereof in any ratio.

Examples of the unsaturated monomer having a glycidyl ether group usable in producing the particulate polymer (C) having a glycidyl ether group as the functional group reactive with the cross-linking agent (B) include glycidyl acrylate and glycidyl methacrylate. Of these, glycidyl methacrylate is preferred. These may be used alone or in combination of two or more thereof in any ratio.

Examples of the monomer unit having a thiol group usable in producing the particulate polymer (C) having a thiol group as the functional group reactive with the cross-linking agent (B) include pentaerythritol tetrakis(3-mercaptobutyrate), trimethylolpropane tris(3-mercaptobutyrate), and trimethylolethane tris(3-mercaptobutyrate). Of these, pentaerythritol tetrakis(3-mercaptobutyrate) is preferred. These may be used alone or in combination of two or more thereof in any ratio.

The functional group reactive with the cross-linking agent (B) in the particulate polymer (C) may be introduced by using the above-described monomers containing the functional group reactive with the cross-linking agent (B) for polymerization. However, the functional group reactive with the cross-linking agent (B) may also be introduced for example by polymerizing particulate polymers without any functional group reactive with the cross-linking agent (B) and then substituting the functional group reactive with the cross-linking agent (B) for some or all of the functional groups in the particulate polymer to prepare the particulate polymer (C). In this regard, the repeat unit in the particulate polymer (C) having the “functional group reactive with the cross-linking agent (B)” introduced as such is also included in the “monomer unit containing the functional group reactive with the cross-linking agent (B)”.

The content percentage of the monomer unit containing the functional group reactive with the cross-linking agent (B) in the particulate polymer (C) is not particularly limited; however, the upper limit is preferably at most 10 mass %, more preferably at most 8 mass %, particularly preferably at most 5 mass %, and the lower limit is preferably not less than 0.5 mass %, more preferably not less than 1.0 mass %, particularly preferably not less than 1.5 mass %. With the content percentage of the above monomers being within the above range, the particulate polymer (C) to be obtained would exhibit superior mechanical stability and chemical stability.

The particulate polymer (C) may contain any additional repeat unit other than the above-described repeat units, as long as intended effects of the disclosed products are not significantly compromised. Examples of the monomer corresponding to the above-mentioned additional repeat unit include a vinyl cyanide monomer, an unsaturated carboxylic acid alkyl ester monomer, and an unsaturated carboxylic acid amide monomer. These may be used alone or in combination of two or more thereof in any ratio.

The content percentage of the monomer corresponding to the additional repeat unit in the particulate polymer (C) is not particularly limited; however, the upper limit in total is preferably at most 10 mass %, more preferably at most 8 mass %, particularly preferably at most 5 mass %, and the lower limit in total is preferably not less than 0.5 mass %, more preferably not less than 1.0 mass %, particularly preferably not less than 1.5 mass %.

Examples of the vinyl cyanide monomer include acrylonitrile, methacrylonitrile, α-chloracrylonitrile, and α-ethylacrylonitrile. Of these, acrylonitrile and methacrylonitrile are preferred. These may be used alone or in combination of two or more thereof in any ratio.

Examples of the unsaturated carboxylic acid alkyl ester monomer include methyl acrylate, methyl methacrylate, ethyl acrylate, ethyl methacrylate, butyl acrylate, dimethyl fumarate, diethyl fumarate, dimethyl maleate, diethyl maleate, dimethyl itaconate, monomethyl fumarate, monoethyl fumarate, and 2-ethylhexyl acrylate. Of these, methyl methacrylate is preferred. These may be used alone or in combination of two or more thereof in any ratio.

Examples of the unsaturated carboxylic acid amide monomer include acrylamide, methacrylamide, N-methylolacrylamide, N-methylol methacrylamide, and N,N-dimethylacrylamide. Of these, acrylamide and methacrylamide are preferred. These may be used alone or in combination of two or more thereof in any ratio.

Further, the particulate polymer (C) may also be produced by monomers used in common emulsion polymerization, such as ethylene, propylene, vinyl acetate, vinyl propionate, vinyl chloride, and vinylidene chloride. These may be used alone or in combination of two or more thereof in any ratio.

The content percentage of the monomer units other than the aliphatic conjugated diene monomer unit, the aromatic vinyl monomer unit, and the monomer unit containing the functional group reactive with the cross-linking agent (B) in the particulate polymer (C) is not particularly limited; however, the upper limit in total is preferably at most 10 mass %, more preferably at most 8 mass %, particularly preferably at most 5 mass %, and the lower limit in total is preferably not less than 0.5 mass %, more preferably not less than 1.0 mass %, particularly preferably not less than 1.5 mass %.

The particulate polymer (C) consisting of a copolymer having the aliphatic conjugated diene monomer unit and the aromatic vinyl monomer unit and the like is produced, for example, by polymerizing a monomer composition containing the above-mentioned monomers in an aqueous solvent.

Here, the content percentages of the monomers in the monomer composition are generally made to be the same as the content percentages of the corresponding repeat units in the desired particulate polymer (C).

The aqueous solvent can be selected from any aqueous solution that allows the particulate polymer (C) to be dispersed therein in the form of particulate and, usually, has a boiling point of usually 80° C. or higher, preferably 100° C. or higher, but usually 350° C. or lower, preferably 300° C. or lower, under normal pressure.

Specific examples of the aqueous solvent include water; ketones, such as diacetone alcohol and γ-butyrolactone; alcohols, such as ethyl alcohol, isopropyl alcohol, and normal-propyl alcohol; glycol ethers, such as propylene glycol monomethyl ether, methyl cellosolve, ethyl cellosolve, ethylene glycol tertiary butyl ether, butyl cellosolve, 3-methoxy-3-methyl-1-butanol, ethylene glycol monopropyl ether, diethylene glycol monobutyl ether, triethylene glycol monobutyl ether, and dipropylene glycol monomethyl ether; and ethers, such as 1,3-dioxolane, 1,4-dioxolane, and tetrahydrofuran. Of these, water is particularly preferred since it is not flammable and easily allows dispersion of the particulates of the particulate polymer (C). In some cases, water may be mainly used as the solvent, but any aqueous solvent mentioned above other than water may be mixed to water as long as the dispersing state of the particulate of the particulate polymer (C) can be secured.

Any polymerization method can be used without particular limitation. For example, solution polymerization, suspension polymerization, bulk polymerization, or emulsion polymerization may be used. Also, any polymerization reaction may be used. For example, ionic polymerization, radical polymerization, or living radical polymerization may be used. Emulsion polymerization is particularly preferred considering the production efficiency. With the emulsion polymerization, high molecular weight product can be easily produced, and the polymerized product can be obtained in the state of being dispersed in water, which eliminates the need to redisperse the product and thus allows the product to be directly used for the production of the disclosed slurry composition for a secondary-battery negative electrode. The emulsion polymerization can be performed by the usual method.

The polymerization can be performed using an emulsifier, a dispersant, a polymerization initiator, a polymerization aid, and the like which are commonly used, and the amount used is also the amount commonly used. For the polymerization, seed polymerization may be performed by employing seed particles. Further, any polymerization conditions can be selected depending on the polymerization method, the kind of polymerization initiator, and the like.

The aqueous dispersion of the particulates of the particulate polymer (C) obtained by any of the above-mentioned polymerization methods may be adjusted to have a pH range of usually 5 or higher, and usually 10 or lower, preferably 9 or lower, using a basic aqueous solution containing for example hydroxides of alkali metals (e.g., Li, Na, K, Rb, and Cs), ammonia, inorganic ammonium compounds (e.g., NH₄Cl), or an organic amine compound (e.g., ethanolamine and diethylamine). The pH adjustment with the use of an alkali metal hydroxide is preferred since it improves the adherence between a current collector and a negative-electrode mixed material layer.

[Properties of Particulate Polymer (C)]

The particulate polymer (C) is usually water-insoluble. Therefore, the particulate polymer (C) usually exists in an aqueous slurry composition in the form of particulate. Maintaining the particulate form, the particulate polymer (C) is included for example in a secondary-battery negative electrode.

The number average particle diameter of the particulate polymer (C) in the disclosed slurry composition for a secondary-battery negative electrode is preferably 50 nm or greater, more preferably 70 nm or greater, but preferably 500 nm or less, more preferably 400 nm or less. With the number average particle diameter being within the above range, the negative electrode to be obtained can have good strength and flexibility. The number average particle diameter can be easily measured for example with a transmission electron microscope method, a Coulter Counter, or a laser diffraction scattering method.

The gel content of the particulate polymer (C) is preferably 50 mass % or more, more preferably 80 mass % or more, but preferably 98 mass % or less, more preferably 95 mass % or less. When the gel content of the particulate polymer (C) is less than 50 mass %, the particulate polymer (C) would decrease its cohesive force, possibly causing insufficient adherence to a current collector or the like. On the other hand, when the gel content of the particulate polymer (C) exceeds 98 mass %, the particulate polymer (C) would lose toughness to become brittle, also possibly causing insufficient adherence.

The “gel content” of the particulate polymer (C) herein can be measured by the measuring method described in the example section of the present specification.

The glass-transition temperature (T_{g}) of the particulate polymer (C) is preferably −30° C. or higher, more preferably −20° C. or higher, but preferably 80° C. or lower, more preferably 30° C. or lower. With the glass-transition temperature of the particulate polymer (C) being −30° C. or higher, the ingredients in the disclosed slurry composition for a secondary-battery negative electrode can be prevented from being cohered to sink. This can ensure the stability of the slurry composition and suppress the expansion of the negative electrode suitably. On the other hand, with the glass-transition temperature of the particulate polymer (C) being 80° C. or lower, good workability can be achieved in applying the disclosed slurry composition for a secondary-battery negative electrode onto a current collector or the like.

The “glass-transition temperature” of the particulate polymer (C) herein can be measured by the measuring method described in the example section of the present specification.

The glass-transition temperature and the gel content of the particulate polymer (C) can be appropriately adjusted by varying the preparation conditions (e.g., monomer to be used, polymerization condition, etc.) of the particulate polymer (C).

Specifically, the glass-transition temperature can be adjusted by varying the kind and the amount of the monomer to be used. For example, the use of the monomer of styrene, acrylonitrile, or the like can raise the glass-transition temperature, and the use of the monomer of butyl acrylate, butadiene, or the like can lower the glass-transition temperature.

The gel content can be adjusted by varying for example the polymerization temperature, the kind of polymerization initiator, the kind and the amount of molecular weight modifier, and the converted percentage at the end of the reaction. For example, if the amount of a chain transfer agent is decreased, the gel content can be increased; and if the amount of a chain transfer agent is increased, the gal content can be decreased.

<Negative Electrode Active Material>

The negative electrode active material is a substance that accepts and donates electrons in the negative electrode of a secondary battery. A description is now made by giving examples of a negative electrode active material used in a negative electrode of a lithium ion secondary battery.

For the negative electrode active material of a lithium ion secondary battery, a material that can occlude and release lithium is usually used. Examples of the material that can occlude and release lithium include a carbon-based negative electrode active material, a non-carbon-based negative electrode active material, and an active material formed by combining these two.

For the disclosed slurry composition for a secondary-battery negative electrode, to increase the capacity of a secondary battery, at least a non-carbon-based negative electrode active material needs to be used as the negative electrode active material.

Here, when a non-carbon-based negative electrode active material is used as the negative electrode active material, the negative electrode active material containing a non-carbon-based negative electrode active material expands and contracts in accordance with charge and discharge. Therefore, when the negative electrode active material containing a non-carbon-based negative electrode active material is used, usually, the negative electrode gradually expands due to the repeated expansion and contraction of the negative electrode active material. This may deform the secondary battery to lower the electrical characteristics such as cycle characteristics. However, a negative electrode formed with the disclosed slurry composition for a secondary-battery negative electrode, which has a cross-linked structure formed by the above-described water-soluble thickener (A), the cross-linking agent (B), and the particulate polymer (C), would be suppressed from expanding caused due to the expansion and contraction of the negative electrode active material, improving the electrical characteristics such as cycle characteristics.

[Non-Carbon-Based Negative Electrode Active Material]

The non-carbon-based negative electrode active material is an active material that excludes carbon-based negative electrode active materials consisting exclusively of a carbonaceous material or a graphitic material. The non-carbon-based negative electrode active material may be for example a metal-based negative electrode active material.

The metal-based negative electrode active material is an active material that contains metal, the structure of which usually contains an element to which lithium can be inserted, and that exhibits, when lithium is inserted, a theoretical electric capacitance of 500 mAh/g or higher per unit mass. Examples of the metal-based negative electrode active material include a lithium metal; a simple substance of metal that can be used to form lithium alloys (e.g., Ag, Al, Ba, Bi, Cu, Ga, Ge, In, Ni, P, Pb, Sb, Si, Sn, Sr, Zn, and Ti); alloys of the simple substance of metal; and oxides, sulfides, nitrides, silicides, carbides, and phosphides of the lithium metal, the simple substance of metal, and the alloys of the simple substance of metal.

Of the metal-based negative electrode active materials, active materials containing silicon (silicon-based negative electrode active materials) are preferred. With the use of the silicon-based negative electrode active material, the capacity of a lithium ion secondary battery can be increased.

Examples of the silicon-based negative electrode active material include silicon (Si), a silicon-containing alloy, SiO, SiOₓ, and a composite material of conductive carbon and a Si-containing material obtained by coating or combining a Si-containing material with conductive carbon.

The silicon-containing alloy may be for example an alloy composition that contains silicon, aluminum, and transition metals such as iron, and further rare-earth elements such as tin and yttrium. Specific examples of the silicon-containing alloy include mixtures of

(A) an amorphous phase containing silicon, and
(B) a nano-crystal phase containing tin, indium, yttrium, lanthanides, actinides, or any combination thereof. More specific examples of the silicon-containing alloy include alloy compositions represented by the general formula (3) below:

SiₐAl_{b}T_{c}Sn_{d}InₑM_{f}Li_{g} (3)

[In the formula, T is a transition metal; M is yttrium, lanthanides, actinides, or any combination thereof; the sum of a, b, c, d, e, and f is equal to 1; 0.35≦a≦0.70; 0.01≦b≦0.45; 0.05≦c≦0.25; 0.01≦d≦0.15; e≦0.15; 0.02≦f≦0.15; 0<g≦{4.4×(a+d+e)+b}.]

Such alloys can be prepared by the method described in JP2013-65569A, or specifically a meltspun method.

SiOₓ is a compound that contains Si and at least one of SiO and SiO₂, where x is usually 0.01 or greater but less than 2. SiO can be formed for example by utilizing the disproportionation reaction of silicon monoxide (SiO). Specifically, SiOₓ can be prepared by heat-treating SiO optionally in the presence of a polymer such as polyvinyl alcohol to form silicon and silicon dioxide. The heat-treatment can be performed, after pulverizing and mixing SiO optionally with a polymer, at a temperature of 900° C. or higher, preferably 1000° C. or higher, in the atmosphere containing an organic gas and/or vapor.

The composite of a Si-containing material and conductive carbon may be, for example, a compound obtained, for example, by heat-treating a pulverized mixture of SiO, a polymer such as polyvinyl alcohol, and optionally a carbon material in an atmosphere containing organic gas and/or vapor. Alternatively, the composite material of Si-containing material and conductive carbon may be obtained for example by coating the surface of SiO particles using a chemical vapor deposition method that uses an organic gas or the like, or by making the SiO particles and graphite or artificial graphite into composite particles (or by granulating the SiO particles and graphite or artificial graphite) by a mechanochemical method, which methods are publicly known in the art.

In this regard, although the use of the above-described silicon-based negative electrode active material, particularly the silicon-containing alloy, may increase the capacity of a lithium ion secondary battery, the silicon-based negative electrode active materials, particularly the silicon-containing alloy, largely expand and contract (for example about five-fold) in accordance with discharge and charge. However, in the negative electrode formed with the disclosed slurry composition for a secondary-battery negative electrode, even when the silicon-based negative electrode active material, particularly the silicon-containing alloy, is used, the cross-linked structure formed by the water-soluble thickener (A), the cross-linking agent (B), and the particulate polymer (C) would sufficiently suppress the expansion of the negative electrode caused by the expansion and contraction of the negative electrode active material.

To increase the capacity of a lithium ion secondary battery while further sufficiently suppressing the expansion of the negative electrode, a mixture of a carbon-based negative electrode active material and a silicon-based negative electrode active material is preferably used as the negative electrode active material.

The mixture of a carbon-based negative electrode active material and a silicon-based negative electrode active material may be obtained by pulverizing and mixing a carbon-based negative electrode active material and the above-mentioned silicon-based negative electrode active material, optionally in the presence of a polymer such as polyvinyl alcohol.

[Carbon-Based Negative Electrode Active Material]

The carbon-based negative electrode active material can be defined as an active material that contains carbon as its main backbone, to which lithium can be inserted (or can be doped). Examples of the carbon-based negative electrode active material include carbonaceous materials and graphitic materials.

A carbonaceous material is a less graphitized (or low crystallinity) material, which can be obtained by carbonizing a carbon precursor by heat-treating it at 2000° C. or lower. The lower limit of the heat treatment temperature in the carbonization is not limited in particular, and it can be, for example, 500° C. or higher.

Examples of the carbonaceous material include graphitizing carbon whose carbon structure can easily be changed according to the heat treatment temperature, and non-graphitizing carbon typified by glassy carbon, which has a structure similar to the amorphous structure.

Here, the graphitizing carbon may be a carbon material made from tar pitch that can be obtained from petroleum or coal. Specific examples of graphitizing carbon include coke, mesocarbon microbeads (MCMB), mesophase pitch-based carbon fiber, and pyrolytic vapor-grown carbon fiber.

Examples of the non-graphitizing carbon include sintered phenolic resin, polyacrylonitrile-based carbon fiber, pseudo-isotropic carbon, sintered furfuryl alcohol resin (PFA), and hard carbon.

The graphitic material is a material having as high crystallinity as graphite. The graphitic material can be obtained by heat-treating graphitizing carbon at 2000° C. or higher. The upper limit of the heat treatment temperature is not limited in particular, and it can be 5000° C. or lower.

Examples of the graphitic material include natural graphite and artificial graphite.

Examples of the artificial graphite include an artificial graphite obtained by heat-treating carbon containing graphitizing carbon mainly at 2800° C. or higher, graphitized MCMB obtained by heat-treating MCMB at 2000° C. or higher, and graphitized mesophase pitch-based carbon fiber obtained by heat-treating mesophase pitch-based carbon fiber at 2000° C. or higher.

When a mixture of the carbon-based negative electrode active material and the silicon-based negative electrode active material is used as the negative electrode active material, to sufficiently increase the capacity of a lithium ion secondary battery while sufficiently suppressing the expansion of the negative electrode, the carbon-based negative electrode active material is preferably artificial graphite; and the silicon-based negative electrode active material is preferably one or more materials selected from the group consisting of Si, a silicon-containing alloy, SiOₓ, and a composite of Si-containing material and conductive carbon, and is further preferably a silicon-containing alloy. When the silicon-containing alloy is used, initial coulombic efficiency and cycle characteristics can be improved while the capacity of a lithium ion secondary battery is sufficiently increased.

When a mixture of the carbon-based negative electrode active material and the silicon-based negative electrode active material is used as the negative electrode active material, to sufficiently increase the capacity of a lithium ion secondary battery while sufficiently suppressing the expansion of the negative electrode, the negative electrode active material contains the silicon-based negative electrode active material in an amount of preferably 30 mass parts or more, particularly preferably 50 mass parts or more, but preferably 99 mass parts or less, particularly preferably 95 mass parts or less, per 100 mass parts of the negative electrode active material. By setting the amount of the silicon-based negative electrode active material per 100 mass parts of the negative electrode active material to 30 mass parts or more, the capacity of a lithium ion secondary battery can be sufficiently increased. On the other hand, according to the disclosed slurry composition for a secondary-battery negative electrode, by setting the amount of the silicon-based negative electrode active material per 100 mass parts of the negative electrode active material to 99 mass parts or less, the expansion of the negative electrode can be sufficiently suppressed.

The particle diameter and the specific surface area of the negative electrode active material may be, but is not limited to, the same as those of the conventionally-used negative electrode active material.

<Other Components>

The disclosed slurry composition for a secondary-battery negative electrode may further contain other components, such as a conductive material, a reinforcing material, a leveling agent, and an electrolysis solution additive, other than the above-described components. The other components may be any publicly known materials that do not affect the battery reaction. For example, those described in WO2012/115096A may be used. These components may be used alone or in combination of two or more thereof in any ratio.

<Preparation of Slurry Composition>

The disclosed slurry composition for a secondary-battery negative electrode may be prepared by optionally premixing part of the above-described components, and then dispersing them into an aqueous medium as a dispersion medium; or may be prepared by preparing a binder composition including the water-soluble thickener (A), the cross-linking agent (B), and the particulate polymer (C), and then dispersing the binder composition and a negative electrode active material into an aqueous medium as a dispersion medium. Considering the dispersibility of each component in the slurry composition, it is preferred that the slurry composition be prepared by dispersing each component into an aqueous medium as a dispersion medium. Specifically, the slurry composition is preferably prepared by mixing the above-described components with the aqueous medium by using a mixer, such as a ball mill, a sand mill, a bead mill, a pigment disperser, a grinding machine, an ultrasonic disperser, a homogenizer, a planetary mixer, and a FILMIX.

Water is typically used as the water medium; alternatively, an aqueous solution of any compound or a mixed solution of a small amount of organic medium and water may be used. The solid content concentration of the slurry composition may be for example 30 mass % or more but 90 mass % or less, more preferably 40 mass % or more but 80 mass % or less, which allows the components to be uniformly dispersed. Further, the mixing of the above components with the aqueous medium can be performed for 10 minutes or more but a few hours or less at a temperature ranging from room temperature to 80° C.

(Secondary-Battery Negative Electrode)

The secondary-battery negative electrode of the disclosure can be produced using the disclosed slurry composition for a secondary-battery negative electrode.

Further, the secondary-battery negative electrode of the disclosure includes a current collector and a negative-electrode mixed material layer formed on the current collector. The negative-electrode mixed material layer can be obtained from the disclosed slurry composition for a secondary-battery negative electrode. According to the secondary-battery negative electrode of the disclosure, the adherence between the current collector and the negative-electrode mixed material layer can be improved and the electrical characteristics of a secondary battery can be improved.

The secondary-battery negative electrode of the disclosure is produced for example through a step of applying the above-described slurry composition for a secondary-battery negative electrode onto a current collector (application step), and a step of drying the slurry composition for a secondary-battery negative electrode applied onto the current collector to form a negative-electrode mixed material layer on the current collector (drying step), and an optional step of further heating the negative-electrode mixed material layer (heating step). When this production method is used, for example, the heat applied in the drying step and the heat applied in the heating step promote the cross-linking reaction via the cross-linking agent (B). In other words, in the negative-electrode mixed material layer, a cross-linked structure is formed between molecules of the water-soluble thickener (A), between molecules of the water-soluble thickener (A) and molecules of the particulate polymer (C), and between molecules of the particulate polymer (C) via the cross-linking agent (B). The cross-linked structure can suppress the expansion caused by charge and discharge and can improve the adherence between the current collector and the negative-electrode mixed material layer, which can further improve the electrical characteristics of a secondary battery by achieving for example good initial coulombic efficiency, good initial resistance, and good cycle characteristics, as well as suppressing the resistance increase after cycles.

Furthermore, when the cross-linked structure is formed, the water-soluble thickener (A), the cross-linking agent (B), and the particulate polymer (C) that are incorporated in the cross-linked structure become hardly dissolved or dispersed in water, so that the water resistance of the negative electrode is improved. Conventionally, in forming a porous membrane on a polar plate having a negative-electrode mixed material layer obtained from an aqueous slurry composition for the purpose of for example improving strength and heat resistance, the use of an aqueous slurry composition for porous membrane may cause elution of a water-soluble component, such as a water-soluble thickener contained in the negative-electrode mixed material layer, into the slurry composition for porous membrane applied onto the negative-electrode mixed material layer. This often results in a problem of impaired battery characteristics. By contrast, the secondary-battery negative electrode formed from the disclosed slurry composition for a secondary-battery negative electrode has improved water resistance as described above, thus sufficiently ensuring battery characteristics even when the porous membrane formed from an aqueous slurry composition for porous membrane is provided on the negative-electrode mixed material layer. Furthermore, the formation of the cross-linked structure loosens the tangled molecular chains in the water-soluble thickener (A) to improve the wettability to an electrolysis solution, thus improving the injectability of an electrolysis solution in producing secondary batteries.

[Application Step]

The above slurry composition for a secondary-battery negative electrode can be applied onto a current collector by any method publicly known. Specifically, the slurry composition may be applied for example by doctor blading, dip coating, reverse roll coating, direct roll coating, gravure coating, extrusion coating, or brush coating. The slurry composition may be applied onto one side or both sides of the current collector. The thickness of the slurry coating applied onto the current collector before drying may be appropriately determined in accordance with the thickness of the negative-electrode mixed material layer to be obtained after drying.

The current collector to be coated with the slurry composition is made of a material having electrical conductivity and electrochemical durability. Specifically, the current collector may be made for example of iron, copper, aluminum, nickel, stainless steel, titan, tantalum, gold, or platinum. Of these, copper foil is particularly preferred as a current collector used for a negative electrode. The above materials may be used alone or in combination of two or more thereof in any ratio.

[Drying Step]

The slurry composition applied onto a current collector may be dried by any method publicly known, for example, drying by warm, hot, or low-humidity air; drying in a vacuum; or drying by irradiation of infrared light or electron beams. The slurry composition on a current collector dried as such forms a negative electrode active material layer on the current collector, thereby providing a secondary-battery negative electrode that includes a current collector and a negative-electrode mixed material layer. When the slurry composition is dried, the heat applied promotes the cross-linking reaction via the cross-linking agent (B).

After the drying step, the negative-electrode mixed material layer may be further subjected to a pressure treatment by mold pressing, roll pressing, or the like. The pressure treatment may improve the adherence between the negative-electrode mixed material layer and the current collector.

After the formation of the negative-electrode mixed material layer, a heating step is preferably performed to promote the cross-linking reaction, thereby obtaining an even more sufficient cross-linked structure. The heating step is performed preferably for about 1 hour or more but 20 hours or less at 80° C. or higher but 160° C. or lower.

(Secondary Battery)

The secondary battery of the disclosure includes a positive electrode, a negative electrode, an electrolysis solution, and a separator, wherein the negative electrode used is the disclosed secondary-battery negative electrode. The secondary battery of the disclosure, which employs the disclosed secondary-battery negative electrode, can improve electrical characteristics while suppressing the expansion of the negative electrode caused by repeated charge and discharge, and also can ensure the adherence between the negative-electrode mixed material layer and the current collector, even when a non-carbon-based negative electrode active material is used. The disclosed secondary battery can find application suitably in, for example, cell-phones such as smartphones, tablets, personal computers, electric vehicles, and stationary-type emergency storage batteries.

<Positive Electrode>

For a positive electrode of a secondary battery, when the secondary battery is, for example, a lithium ion secondary battery, a known positive electrode used as the positive electrode of a lithium ion secondary battery can be used. Specifically, the positive electrode used may be, for example, a positive electrode obtained by forming a positive-electrode mixed material layer on a current collector.

The current collector used may be made of a metal material such as aluminum. The positive-electrode mixed material layer may be a layer containing a known positive electrode active material, a conductive material, and a binder, wherein the binder may be a particulate polymer known in the art.

<Electrolysis Solution>

The electrolysis solution used may be formed by dissolving an electrolyte in a solvent.

The solvent used here may be an organic solvent that can dissolve an electrolyte. Specifically, the solvent may be an alkyl carbonate solvent, such as ethylene carbonate, propylene carbonate, and γ-butyrolactone, to which a viscosity modification solvent, such as 2,5-dimethyl tetrahydrofuran, tetrahydrofuran, diethyl carbonate, ethylmethyl carbonate, dimethyl carbonate, methyl acetate, dimethoxyethane, dioxolane, methyl propionate, and methyl formate, is added.

A lithium salt can be used as the electrolyte. Examples of the lithium salt include those described in JP2012-204303A. Of the lithium salts, LiPF₆, LiClO₄, and CF₃SO₃Li are preferred as electrolytes because they readily dissolve in organic solvents and exhibit a high degree of dissociation.

The electrolysis solution may be a gel electrolyte that contains a polymer and the above electrolysis solution, or may be an intrinsic polymer electrolyte.

<Separator>

Examples of the separator used include those described in JP2012-204303A. Of these, a fine porous membrane made of polyolefinic resin (i.e., polyethylene, polypropylene, polybutene, and polyvinyl chloride) is preferred, since such a membrane can reduce the total thickness of the separator, which increases the proportion of the electrode active material in the secondary battery, consequently increasing the capacity per volume. The separator used may be a separator including a porous membrane obtained by binding non-conductive particles with a particulate polymer known in the art.

<Method of Producing Secondary Battery>

The secondary battery of the disclosure may be produced, for example, by stacking a positive electrode and a negative electrode with a separator provided therebetween, for example rolling or folding the resulting laminate as necessary in accordance with the battery shape to place them in a battery container, injecting an electrolysis solution into the battery container, and sealing the container. To prevent the increase in the pressure inside the lithium ion secondary battery and the occurrence of overcharge/overdischarge and the like, the lithium ion secondary battery may include an overcurrent preventing device such as a fuse or a PTC device, expanded metal, a lead plate, and the like as necessary. The secondary battery may have any shape, such as, a coin, a button, a sheet, a cylinder, a square, or a plane.

### EXAMPLES

Hereinafter, the disclosed products will be specifically described with reference to examples; however, the disclosure is not limited to those examples. In the following, “%” and “parts” used to express quantities are by mass, unless otherwise specified.

In the following examples and comparative examples, the glass-transition temperature and gel content of the particulate polymer (C); the initial coulombic efficiency, the initial resistance, the cycle characteristics, and the suppression of resistance increase after cycles of the secondary battery; the adherence between the negative-electrode mixed material layer and the current collector were each evaluated using the methods described below.

<Glass-Transition Temperature of Particulate Polymer (C)>

A water dispersion containing the particulate polymer (C) was dried for 3 days in an environment of a humidity of 50% and temperatures of 23° C. or higher but 25° C. or lower, to obtain a film having a thickness of 1±0.3 mm. This film was dried for 1 hour in a hot air oven at 120° C. After that, using the film dried as a sample, the glass-transition temperature (° C.) was measured using DSC6220SII (Differential Scanning calorimeter, manufactured by

NanoTechnology Inc.) under the conditions of a measurement temperature of −100° C. or higher but 180° C. or lower and a temperature rise rate of 5° C./min in accordance with JIS K 7121.

### <Gel Content of Particulate Polymer (C)>

A water dispersion containing the particulate polymer (C) was dried in an environment of a humidity of 50% and temperatures of 23° C. or higher but 25° C. or lower, to obtain a film having a thickness of 3±0.3 mm. The film was cut into 1 mm square pieces, and each of the pieces having a mass of about 1 g was precisely weighed.

The mass of a film piece obtained by the cut is denoted as “w0”. The film piece was immersed in 10 g of tetrahydrofuran (THF) for 24 hours in an environment of 25° C.±1° C. After that, the film piece was taken out of THF and vacuum-dried for 3 hours at 105° C., to measure an insoluble mass “w1”.

The gel content (mass %) was then calculated in accordance with the following expression:

Gel content (mass %)=(w1/w0)×100

### <Initial Coulombic Efficiency>

A fabricated laminated cell lithium ion secondary battery was left to stand for 5 hours after injection of an electrolysis solution. Subsequently, the battery was charged (the quantity of charge is defined as C1 (mAh)) to a cell voltage of 3.65 V by the constant-current method at 0.2 C in an atmosphere of 25° C. After that, the temperature was raised to 60° C. and aging was performed for 12 hours. The battery was then discharged (the quantity of discharge is defined as D1 (mAh)) to a cell voltage of 2.75 V by the constant-current method at 0.2 C in an atmosphere of 25° C.

Subsequently, a CC-CV charge (maximum cell voltage: 4.20 V) was performed in an atmosphere of 25° C. at a constant current of 0.2 C (the quantity of charge is defined as C2 (mAh)) and then a CC discharge (minimum voltage: 2.75 V) (the quantity of discharge is defined as D2 (mAh)) was performed in an atmosphere of 25° C. at a constant current of 0.2 C.

The initial coulombic efficiency was defined as {(D1+D2)/(C1+C2)}×100(%), and was rated based on the criteria below.

A: the initial coulombic efficiency is 84% or higher

B: the initial coulombic efficiency is 83% or higher but less than 84%

C: the initial coulombic efficiency is 81% or higher but less than 83%

D: the initial coulombic efficiency is less than 81%

### <Initial Resistance>

A fabricated laminated cell lithium ion secondary battery was left to stand for 5 hours after injection of an electrolysis solution. Subsequently, the battery was charged to a cell voltage of 3.65 V by the constant-current method at 0.2 C in an atmosphere of 25° C. After that, the temperature was raised to 60° C. and aging was performed for 12 hours. The battery was then discharged to a cell voltage of 2.75 V by the constant-current method at 0.2 C in an atmosphere of 25° C.

The lithium ion secondary battery was then charged to a cell voltage of 3.82 V by the constant-current method at 0.1 C in an atmosphere of 25° C. and was left to stand for 5 hours in that state, and then the voltage of the secondary battery “V₀” was measured. Subsequently, discharging operation at 1.5 C was performed in an environment of −10° C., and a voltage “V₂₀”, which is a voltage 20 seconds after the discharge initiation, was measured.

The initial resistance was defined by a voltage change given by ΔVᵢₙᵢ=V₀-V₂₀, and was rated based on the criteria below. Smaller voltage change indicates better initial resistance.

A: ΔVᵢₙᵢ is 1.00 V or less

B: ΔVᵢₙᵢ is more than 1.00 V but 1.05 V or less

C: ΔVᵢₙᵢ is more than 1.05 V but 1.10 V or less

D: ΔVᵢₙᵢ is more than 1.10 V

### <Cycle Characteristics>

The lithium ion secondary battery for which the above initial resistance has been measured was discharged to a cell voltage of 2.75 V by the constant-current method at 0.2 C in an atmosphere of 25° C.

Further, in an environment of 45° C., a 50-cycle charge/discharge operation was performed at a charge/discharge rate of 0.5 C at 4.2 V. In this operation, the capacity of the first cycle, or specifically an initial discharge capacity “X1”, and the discharge capacity of the 50th cycle “X2” were measured, and a capacity change rate given by ΔC′=(X2/X1)×100(%) was determined and rated based on the criteria below. Higher capacity change rates ΔC′ indicate better cycle characteristics.

A: ΔC′ is 85% or higher

B: ΔC′ is 83% or higher but less than 85%

C: ΔC′ is 80% or higher but less than 83%

D: ΔC′ is less than 80%

<Suppression of Resistance Increase after Cycles>

The lithium ion secondary battery for which the above cycle characteristics have been measured was discharged to a cell voltage of 2.75 V by the constant-current method at 0.05 C at 25° C. After that, the lithium ion secondary battery was charged to a cell voltage of 3.82 V by the constant-current method at 0.1 C at 25° C. and was left to stand for 5 hours in that state, and then the voltage of the secondary battery “V′₀” was measured. Subsequently, in an environment of −10° C., discharging operation at 1.5 C was performed and then a voltage “V′₂₀”, which is a voltage 20 seconds after the discharge initiation, was measured. Then, the resistance after cycles defined by a voltage change given by ΔV_{fin}=V′₀-V′₂₀ was calculated.

The resistance increase rate after cycles was defined by ΔV_{fin}/ΔVᵢₙᵢ and rated based on the criteria below. Smaller resistance increase rates ΔV_{fin}/ΔVᵢₙᵢ indicate better suppression of resistance increase by cycles.

A: ΔV_{fin}/ΔVᵢₙᵢ is 110% or less

B: ΔV_{fin}/ΔVᵢₙᵢ is higher than 110% but 120% or less

C: ΔV_{fin}/ΔVᵢₙᵢ is higher than 120% but 130% or less

D: ΔV_{fin}/ΔVᵢₙᵢ is higher than 130%

### <Adherence Between Negative-Electrode Mixed Material Layer and Current Collector>

A fabricated secondary-battery negative electrode was cut into test pieces of a rectangular shape having a length of 100 mm and a width of 10 mm. With the surface of the test piece on which the negative-electrode mixed material layer is formed facing down, a piece of cellophane tape (defined in accordance with JIS Z1522) was pasted to the surface of the negative-electrode mixed material layer. Then, one end of the current collector was vertically pulled at a pulling rate of 50 mm/min to peel off the current corrector, and the stress applied was measured (the cellophane tape was secured to the test bench). The measurement was performed three times to calculate the average thereof. The average, determined as the peel strength, was rated based on the criteria below. Larger peel strength indicates better adherence between the negative-electrode mixed material layer and the current collector.

A: the peel strength is 30 N/m or greater

B: the peel strength is 25 N/m or greater but less than 30 N/m

C: the peel strength is 20 N/m or greater but less than 25 N/m

D: the peel strength is less than 20 N/m

(Materials Used)

To prepare the slurry composition for a secondary-battery negative electrode, the following water-soluble thickener (A), cross-linking agent (B), particulate polymer (C), and negative electrode active material were used.

### [Water-Soluble Thickener (A)]

CMC1: sodium salt of carboxymethyl cellulose (manufacturer: NIPPON PAPER Chemicals CO., LTD., product name: MAC350HC, degree of etherification: 0.8, viscosity of 1% aqueous solution: 3500 mPa·s)

PAA1: polyacrylic acid (manufacturer: Aldrich, weight-average molecular weight: 450 thousand)

### [Cross-Linking Agent (B)]

Cross-linking agent B1: multifunctional epoxy compound (manufacturer: Nagase Chemtex Corporation, product name: EX-313, the number of functional groups: three per molecule (a mixture of a compound having two epoxy groups and one hydroxy group per molecule and a compound having three epoxy groups), water solubility: 90% or higher, viscosity of 1% aqueous solution: 140 mPa·s, one-phase water-solution)

Cross-linking agent B2: 2,2′-bis(2-oxazoline) (manufacturer: Tokyo Chemical Industry Co., Ltd., oxazoline equivalent: 70, one-phase water-solution)

Cross-linking agent B3: polycarbodiimide (manufacturer: Nisshinbo Chemical Inc., product name: CARBODILITE (registered trademark) SV-02, NCN equivalent: 429, one-phase aqueous solution)

### [Particulate Polymer (C)]

Particulate polymer C1 (a polymer having a carboxyl group and a hydroxy group) was prepared as follows:

A 5-MPa pressure vessel equipped with a stirrer was charged with 65 parts of styrene as an aromatic vinyl monomer, 35 parts of 1,3-butadiene as an aliphatic conjugated diene monomer, 2 parts of itaconic acid as an ethylenic unsaturated carboxylic acid monomer, 1 part of 2-hydroxyethyl acrylate as a hydroxy group-containing monomer, 0.3 parts of t-dodecyl mercaptan as a molecular weight modifier, 5 parts of sodium dodecylbenzenesulfonate as an emulsifier, 150 parts of deionized water as a solvent, and 1 part of potassium persulfate as a polymerization initiator. The charged materials were sufficiently stirred and warmed to 55° C. to initiate polymerization.

When the monomer consumption reached 95.0%, the vessel was cooled to terminate the reaction. To the water dispersion containing the polymer obtained as such, a 5% sodium hydroxide aqueous solution was added to adjust the pH of the water dispersion to 8. After that, unreacted monomers were removed by heated vacuum distillation. After that, the water dispersion was cooled to 30° C. or lower to obtain a water dispersion of particulate polymer C1. Using the water dispersion of particulate polymer C1 obtained, the gel content and the glass-transition temperature of particulate polymer C1 was measured by the above-mentioned methods. The measured results demonstrated that the gel content was 92% and the glass-transition temperature (Tg) was 10° C.

### [Negative Electrode Active Material]

Active material 1: mixture of 50 parts of silicon-containing alloy (non-carbon-based negative electrode active material, manufacturer: 3M, product name: L-20772) and 50 parts of artificial graphite (carbon-based negative electrode active material)

Active material 2: mixture of 30 parts of SiOₓ (non-carbon-based negative electrode active material, manufacturer: Shin-Etsu Chemical Co., Ltd.) and 70 parts of artificial graphite (carbon-based negative electrode active material)

Active material 3: mixture of 10 parts of Si (non-carbon-based negative electrode active material, manufacturer: JAPAN PURE CHEMICAL Co., Ltd., reagent grade) and 90 parts of artificial graphite (carbon-based negative electrode active material)

### Example 1

### Preparation of Slurry Composition for Secondary-Battery Negative Electrode

A planetary mixer was charged with 100 parts of active material 1 as a negative electrode active material; 2 parts of Super C45 (manufactured by TIMICAL) as a conductive material; 0.98 parts of 1% aqueous solution of CMC1, in terms of solid content, and 0.02 parts of 1% aqueous solution of PAA1 (whose pH has been adjusted to pH 8 with NaOH), in terms of solid content, as the water-soluble thickener (A); 0.05 parts of cross-linking agent Bl, in terms of solid content, as the cross-linking agent (B); and 1.5 parts of the water dispersion of particulate polymer Cl, in terms of solid content, as the particulate polymer (C). To this, deionized water was further added and mixed to adjust the solid content concentration to 52%. In this manner, a slurry composition for a secondary-battery negative electrode that includes CMC1, PAA1, cross-linking agent B1, particulate polymer C1, and active material 1 was prepared.

### <Production of Negative Electrode>

The above-described slurry composition for a secondary-battery negative electrode was applied onto a piece of copper foil (current collector) having a thickness of 20 μm, using a comma coater, such that the applied amount becomes 5.0 mg/cm² or more but 5.4 mg/cm² or less. The copper foil coated with the slurry composition for a secondary-battery negative electrode was transported through an oven at 60° C. over 2 minutes and further through an oven at 120° C. over 2 minutes, at a rate of 0.3 m/min. The slurry composition applied onto the copper foil was thus dried and a web of negative electrode was obtained.

The web of negative electrode obtained as such was then pressed with a roll press such that the density of the mixed material layer becomes 1.63 g/cm³ or more, but 1.67 g/cm³ or less. Further, for the purpose of further promoting water removal and cross-linking, the web was left for 10 hours in an environment of a vacuum at 120° C. In this manner, a negative electrode obtained by forming a negative-electrode mixed material layer on a current collector was provided.

Using the negative electrode as fabricated, the adherence between the negative-electrode mixed material layer and the current collector was evaluated. The results are shown in Table 1.

### <Production of Positive Electrode>

A planetary mixer was charged with 100 parts of LiCoO₂ as a positive electrode active material, 2 parts of acetylene black (“HS-100”, manufactured by DENKI KAGAKU KOGYO KABUSHIKI KAISHA) as a conductive material, and 2 parts of PVDF (polyvinylidene fluoride, “KF-1100” manufactured by KUREHA CORPORATION). To this, N-methylpyrrolidone was further added and mixed to adjust the total solid-content concentration to 67%, and a slurry composition for a secondary-battery positive electrode was prepared.

The slurry composition for a secondary-battery positive electrode obtained was applied onto a piece of aluminum foil having a thickness of 20 μm using a comma coater such that the applied amount becomes 17.5 mg/cm² or more but 18.4 mg/cm² or less, and then was dried. This drying was performed by transporting the aluminum foil through an oven at 60° C. at a rate of 0.5 m/min over 2 minutes. After that, the aluminum foil was heat-treated for 2 minutes at 120° C., and a web of positive electrode was obtained.

The web of positive electrode obtained was then pressed with a roll press such that the density of the mixed material layer after pressing becomes 3.40 g/cm³ or more, but 3.50 g/cm³ or less. Further, for the purpose of removing water, the web was left for 3 hours in an environment of a vacuum at 120° C. In this manner, a positive electrode obtained by forming a positive-electrode mixed material layer on a current collector was provided.

### <Production of Lithium Ion Secondary Battery>

A single-layer separator made of polypropylene (having a width of 65 mm, a length of 500 mm, and a thickness of 25 μm; produced by a dry method; and having a porosity of 55%) was prepared, and a square piece having a size of 5 cm by 5 cm was cut out of the separator. Further, an aluminum packing case was prepared as a case of the battery.

The positive electrode as fabricated was then cut into a rectangular piece having a size of 3.8 cm by 2.8 cm, and the positive electrode piece was arranged such that the surface of the current-collector side contacts with the aluminum packing case. On the side of the positive-electrode mixed material layer of the positive electrode, the above square separator was arranged. Further, the negative electrode as fabricated was cut into a rectangular piece having a size of 4.0 cm by 3.0 cm, and this rectangular piece was arranged on the separator such that the surface of the negative-electrode mixed material layer side faces the separator. Then, a LiPF₆ solution at a concentration of 1.0 M was charged as an electrolysis solution. The solvent of the LiPF₆ solution was a mixture solvent of ethylene carbonate (EC)/ethylmethyl carbonate (EMC)=3/7 (volume ratio), which contains 2 volume % vinylene carbonate (in terms of solvent ratio) as an additive. The aluminum case was then closed by heat sealing at 150° C. to tightly seal up the opening of the aluminum packing. In this manner, a laminated cell lithium ion secondary battery was produced.

The lithium ion secondary battery as fabricated was evaluated for its initial coulombic efficiency, initial resistance, cycle characteristics, and resistance increase suppression after cycles. The results are shown in Table 1.

### Examples 2 and 3

Other than using the cross-linking agent B2 and the cross-linking agent B3, respectively, in place of the cross-linking agent B1, the procedure of Example 1 was followed to produce slurry compositions for a secondary-battery negative electrode, negative electrodes, positive electrodes, and lithium ion secondary batteries. The evaluations were then performed in the same manner as Example 1. The results are shown in Table 1.

### Examples 4 to 6

Other than setting the blending amounts of the cross-linking agent B3 to 0.02, 0.10, and 0.25 parts, in terms of solid content, respectively, the procedure of Example 3 was followed to produce slurry compositions for a secondary-battery negative electrode, negative electrodes, positive electrodes, and lithium ion secondary batteries. The evaluations were then performed in the same manner as Example 1. The results are shown in Table 1.

### Example 7

Other than using 1 part of CMC1 alone, in terms of solid content, as the water-soluble thickener (A), the procedure of Example 3 was followed to produce a slurry composition for a secondary-battery negative electrode, a negative electrode, a positive electrode, and a lithium ion secondary battery. The evaluations were then performed in the same manner as Example 1. The results are shown in Table 1.

### Examples 8 and 9

Other than using the active material 2 and active material 3, in place of the active material 1, as the negative electrode active material, respectively, the procedure of Example 3 was followed to produce slurry compositions for a secondary-battery negative electrode, negative electrodes, positive electrodes, and lithium ion secondary batteries. The evaluations were then performed in the same manner as Example 1. The results are shown in Table 1.

### Comparative Examples 1 to 3

Other than not using the cross-linking agent B3, the procedures of Examples 3, 8, and 9 were followed, respectively, to produce slurry compositions for secondary-battery negative electrodes, negative electrodes, positive electrodes, and lithium ion secondary batteries. The evaluations were then performed in the same manner as Example 1. The results are shown in Table 1.

### Examples 10 to 12

Other than changing the blending amounts of CMC1 and PAA1 as the water-soluble thickener (A) as shown in Table 2, the procedure of Example 9 was followed to produce slurry compositions for secondary-battery negative electrodes, negative electrodes, positive electrodes, and lithium ion secondary batteries. The evaluations were then performed in the same manner as Example 1. The results are shown in Table 2.

### Examples 13 to 17

Other than changing the blending amounts of the cross-linking agent B3 as the cross-linking agent (B) as shown in Table 2, the procedure of Example 10 was followed to produce slurry compositions for secondary-battery negative electrodes, negative electrodes, positive electrodes, and lithium ion secondary batteries. The evaluations were then performed in the same manner as Example 1. The results are shown in Table 2.

### Examples 18 to 21

Other than changing the blending amounts of the particulate polymer C1 as the particulate polymer (C) as shown in Table 2, the procedure of Example 10 was followed to produce slurry compositions for secondary-battery negative electrodes, negative electrodes, positive electrodes, and lithium ion secondary batteries. The evaluations were then performed in the same manner as Example 1. The results are shown in Table 2.

### Examples 22 to 23

Other than changing the blending amounts of CMC1 and PAA1 as the water-soluble thickener (A) as shown in Table 2, the procedure of Example 20 was followed to produce slurry compositions for secondary-battery negative electrodes, negative electrodes, positive electrodes, and lithium ion secondary batteries. The evaluations were then performed in the same manner as Example 1. The results are shown in Table 2.

### Comparative Example 4

Other than changing the blending amounts of CMC1 and PAA1 as the water-soluble thickener (A) as shown in Table 2, the procedure of Example 10 was followed to produce a slurry composition for secondary-battery negative electrodes, a negative electrode, a positive electrode, and a lithium ion secondary battery. However, sufficient thickening effect was not obtained so that the preparation of a slurry composition for a secondary-battery negative electrode resulted in a failure.

### Comparative Example 5

Other than changing the blending amount of the cross-linking agent B3 as the cross-linking agent (B) as shown in Table 2, the procedure of Example 10 was followed to produce a slurry composition for a secondary-battery negative electrode, a negative electrode, a positive electrode, and a lithium ion secondary battery. The evaluations were then performed in the same manner as Example 1. The results are shown in Table 2.

### Comparative Example 6

Other than changing the blending amount of the particulate polymer C1 as the particulate polymer (C) as shown in Table 2, the procedure of Example 10 was followed to produce a slurry composition for a secondary-battery negative electrode, a negative electrode, a positive electrode, and a lithium ion secondary battery. The evaluations were then performed in the same manner as Example 1. The results are shown in Table 2.

### Comparative Example 7

Other than not using the particulate polymer C1 as the particulate polymer (C), the procedure of Example 10 was followed to produce a slurry composition for a secondary-battery negative electrode, a negative electrode, a positive electrode, and a lithium ion secondary battery. The evaluations were then performed in the same manner as Example 1. The results are shown in Table 2.

TABLE 1

| | | | Example 1 | Example 2 | Example 3 | Example 4 | Example 5 | Example 6 |
|---|---|---|---|---|---|---|---|---|
| Slurry | Negative | Kind | Active | Active | Active | Active | Active | Active |
| compo- | electrode | | material 1 | material 1 | material 1 | material 1 | material 1 | material 1 |
| sition for | active | Blending amount [mass parts] | 100 | 100 | 100 | 100 | 100 | 100 |
| secondary- | material | | | | | | | |
| battery | Water-soluble | CMC1 blending amount [mass parts] | 0.98 | 0.98 | 0.98 | 0.98 | 0.98 | 0.98 |
| negative | thickener (A) | PAA1 blending amount [mass parts] | 0.02 | 0.02 | 0.02 | 0.02 | 0.02 | 0.02 |
| electrode | | PAA1/CMC1 + PAA1 [mass %] | 2.00 | 2.00 | 2.00 | 2.00 | 2.00 | 2.00 |
| | | Total blending amount [mass parts] | 1.00 | 1.00 | 1.00 | 1.00 | 1.00 | 1.00 |
| | Cross- | Kind | Cross- | Cross- | Cross- | Cross- | Cross- | Cross- |
| | linking | | linking | linking | linking | linking | linking | linking |
| | agent (B) | | agent B1 | agent B2 | agent B3 | agent B3 | agent B3 | agent B3 |
| | | Blending amount [mass parts] | 0.05 | 0.05 | 0.05 | 0.02 | 0.10 | 0.25 |
| | | Blending amount | 5.00 | 5.00 | 5.00 | 2.00 | 10.00 | 25.00 |
| | | [mass parts/100 mass parts of | | | | | | |
| | | water-soluble thickener (A)] | | | | | | |
| | Particulate | Kind | Polymer | Polymer | Polymer | Polymer | Polymer | Polymer |
| | polymer (C) | | C1 | C1 | C1 | C1 | C1 | C1 |
| | | Kind of functional group | carboxyl | carboxyl | carboxyl | carboxyl | carboxyl | carboxyl |
| | | | group + | group + | group + | group + | group + | group + |
| | | | hydroxy | hydroxy | hydroxy | hydroxy | hydroxy | hydroxy |
| | | | group | group | group | group | group | group |
| | | Gel content [mass %] | 92 | 92 | 92 | 92 | 92 | 92 |
| | | Glass transition temperature | 10 | 10 | 10 | 10 | 10 | 10 |
| | | [degrees C.] | | | | | | |
| | | Blending amount [mass parts] | 1.5 | 1.5 | 1.5 | 1.5 | 1.5 | 1.5 |
| | | Blending amount | 150.0 | 150.0 | 150.0 | 150.0 | 150.0 | 150.0 |
| | | [mass parts/100 mass parts of | | | | | | |
| | | water-soluble thickener (A)] | | | | | | |
| Evaluation | Initial coulombic efficiency | | A | A | A | A | A | B |
| | Initial resistance | | B | B | A | B | A | A |
| | Cycle characteristics | | B | B | A | B | A | B |
| | Suppression of resistance increase after cycles | | A | A | A | B | A | A |
| | Adherence between negative-electrode mixed | | B | B | A | B | A | B |
| | material layer and current collector | | | | | | | |
| | | | | | | Com. | Com. | Com. |
| | | | Example 7 | Example 8 | Example 9 | Example 1 | Example 2 | Example 3 |
| Slurry | Negative | Kind | Active | Active | Active | Active | Active | Active |
| compo- | electrode | | material 1 | material 2 | material 3 | material 1 | material 2 | material 3 |
| sition for | active | Blending amount [mass parts] | 100 | 100 | 100 | 100 | 100 | 100 |
| secondary- | material | | | | | | | |
| battery | Water-soluble | CMC1 blending amount [mass parts] | 1.00 | 0.98 | 0.98 | 0.98 | 0.98 | 0.98 |
| negative | thickener (A) | PAA1 blending amount [mass parts] | — | 0.02 | 0.02 | 0.02 | 0.02 | 0.02 |
| electrode | | PAA1/CMC1 + PAA1 [mass %] | — | 2.00 | 2.00 | 2.00 | 2.00 | 2.00 |
| | | Total blending amount [mass parts] | 1.00 | 1.00 | 1.00 | 1.00 | 1.00 | 1.00 |
| | Cross- | Kind | Cross- | Cross- | Cross- | — | — | — |
| | linking | | linking | linking | linking | | | |
| | agent (B) | | agent B3 | agent B3 | agent B3 | | | |
| | | Blending amount [mass parts] | 0.05 | 0.05 | 0.05 | — | — | — |
| | | Blending amount | 5.00 | 5.00 | 5.00 | — | — | — |
| | | [mass parts/100 mass parts of | | | | | | |
| | | water-soluble thickener (A)] | | | | | | |
| | Particulate | Kind | Polymer | Polymer | Polymer | Polymer | Polymer | Polymer |
| | polymer (C) | | C1 | C1 | C1 | C1 | C1 | C1 |
| | | Kind of functional group | carboxyl | carboxyl | carboxyl | carboxyl | carboxyl | carboxyl |
| | | | group + | group + | group + | group + | group + | group + |
| | | | hydroxy | hydroxy | hydroxy | hydroxy | hydroxy | hydroxy |
| | | | group | group | group | group | group | group |
| | | Gel content [mass %] | 92 | 92 | 92 | 92 | 92 | 92 |
| | | Glass transition temperature | 10 | 10 | 10 | 10 | 10 | 10 |
| | | [degrees C.] | | | | | | |
| | | Blending amount [mass parts] | 1.5 | 1.5 | 1.5 | 1.5 | 1.5 | 1.5 |
| | | Blending amount | 150.0 | 150.0 | 150.0 | 150.0 | 150.0 | 150.0 |
| | | [mass parts/100 mass parts of | | | | | | |
| | | water-soluble thickener (A)] | | | | | | |

| | | | | | | | |
|---|---|---|---|---|---|---|---|
| Evaluation | Initial coulombic efficiency | B | C | C | D | D | D |
| | Initial resistance | B | C | C | D | D | D |
| | Cycle characteristics | B | C | C | D | D | D |
| | Suppression of resistance increase after cycles | B | C | C | D | D | D |
| | Adherence between negative-electrode mixed | B | C | C | D | D | D |
| | material layer and current collector | | | | | | |

TABLE 2

| | | | Exam- | Exam- | Exam- | Exam- | Exam- | Exam- |
|---|---|---|---|---|---|---|---|---|
| | | | ple 10 | ple 11 | ple 12 | ple 13 | ple 14 | ple 15 |
| Slurry | Negative | Kind | Active | Active | Active | Active | Active | Active |
| compo- | electrode | | material 3 | material 3 | material 3 | material 3 | material 3 | material 3 |
| sition for | active | Blending amount [mass parts] | 100 | 100 | 100 | 100 | 100 | 100 |
| secondary- | material | | | | | | | |
| battery | Water-soluble | CMC1 blending amount [mass parts] | 1.96 | 2.94 | 4.90 | 1.96 | 1.96 | 1.96 |
| negative | thickener (A) | PAA1 blending amount [mass parts] | 0.04 | 0.06 | 0.10 | 0.04 | 0.04 | 0.04 |
| electrode | | PAA1/CMC1 + PAA1 [mass %] | 2.00 | 2.00 | 2.00 | 2.00 | 2.00 | 2.00 |
| | | Total blending amount [mass parts] | 2.00 | 3.00 | 5.00 | 2.00 | 2.00 | 2.00 |
| | Cross- | Kind | Cross- | Cross- | Cross- | Cross- | Cross- | Cross- |
| | linking | | linking | linking | linking | linking | linking | linking |
| | agent (B) | | agent B3 | agent B3 | agent B3 | agent B3 | agent B3 | agent B3 |
| | | Blending amount [mass parts] | 0.05 | 0.05 | 0.05 | 0.10 | 0.20 | 1.00 |
| | | Blending amount | 2.50 | 1.67 | 1.00 | 5.00 | 10.00 | 50.00 |
| | | [mass parts/100 mass parts of | | | | | | |
| | | water-soluble thickener (A)] | | | | | | |
| | Particulate | Kind | Polymer | Polymer | Polymer | Polymer | Polymer | Polymer |
| | polymer (C) | | C1 | C1 | C1 | C1 | C1 | C1 |
| | | Kind of funtional group | carboxyl | carboxyl | carboxyl | carboxyl | carboxyl | carboxyl |
| | | | group + | group + | group + | group + | group + | group + |
| | | | hydroxy | hydroxy | hydroxy | hydroxy | hydroxy | hydroxy |
| | | | group | group | group | group | group | group |
| | | Gel content [mass %] | 92 | 92 | 92 | 92 | 92 | 92 |
| | | Glass transition temperature | 10 | 10 | 10 | 10 | 10 | 10 |
| | | [degrees C.] | | | | | | |
| | | Blending amount [mass parts] | 1.5 | 1.5 | 1.5 | 1.5 | 1.5 | 1.5 |
| | | Blending amount | 75.0 | 50.0 | 30.0 | 75.0 | 75.0 | 75.0 |
| | | [mass parts/100 mass parts of | | | | | | |
| | | water-soluble thickener (A)] | | | | | | |
| Evaluation | Initial coulombic efficiency | | B | A | C | A | A | B |
| | Initial resistance | | B | A | C | A | A | C |
| | Cycle characteristics | | B | A | C | A | A | B |
| | Suppression of resistance increase after cycles | | B | B | C | A | A | B |
| | Adherence between negative-electrode mixed | | B | B | B | A | A | C |
| | material layer and current collector | | | | | | | |
| | | | Exam- | Exam- | Exam- | Exam- | Exam- | Exam- |
| | | | ple 16 | ple 17 | ple 18 | ple 19 | ple 20 | ple 21 |
| Slurry | Negative | Kind | Active | Active | Active | Active | Active | Active |
| compo- | electrode | | material 3 | material 3 | material 3 | material 3 | material 3 | material 3 |
| sition for | active | Blending amount [mass parts] | 100 | 100 | 100 | 100 | 100 | 100 |
| secondary- | material | | | | | | | |
| battery | Water-soluble | CMC1 blending amount [mass parts] | 1.96 | 1.96 | 1.96 | 1.96 | 1.96 | 1.96 |
| negative | thickener (A) | PAA1 blending amount [mass parts] | 0.04 | 0.04 | 0.04 | 0.04 | 0.04 | 0.04 |
| electrode | | PAA1/CMC1 + PAA1 [mass %] | 2.00 | 2.00 | 2.00 | 2.00 | 2.00 | 2.00 |
| | | Total blending amount [mass parts] | 2.00 | 2.00 | 2.00 | 2.00 | 2.00 | 2.00 |
| | Cross- | Kind | Cross- | Cross- | Cross- | Cross- | Cross- | Cross- |
| | linking | | linking | linking | linking | linking | linking | linking |
| | agent (B) | | agent B3 | agent B3 | agent B3 | agent B3 | agent B3 | agent B3 |
| | | Blending amount [mass parts] | 3.00 | 5.00 | 0.05 | 0.05 | 0.05 | 0.05 |
| | | Blending amount | 150.00 | 250.00 | 2.50 | 2.50 | 2.50 | 2.50 |
| | | [mass parts/100 mass parts of | | | | | | |
| | | water-soluble thickener (A)] | | | | | | |
| | Particulate | Kind | Polymer | Polymer | Polymer | Polymer | Polymer | Polymer |
| | polymer (C) | | C1 | C1 | C1 | C1 | C1 | C1 |
| | | Kind of funtional group | carboxyl | carboxyl | carboxyl | carboxyl | carboxyl | carboxyl |
| | | | group + | group + | group + | group + | group + | group + |
| | | | hydroxy | hydroxy | hydroxy | hydroxy | hydroxy | hydroxy |
| | | | group | group | group | group | group | group |
| | | Gel content [mass %] | 92 | 92 | 92 | 92 | 92 | 92 |
| | | Glass transition temperature | 10 | 10 | 10 | 10 | 10 | 10 |
| | | [degrees C.] | | | | | | |
| | | Blending amount [mass parts] | 1.5 | 1.5 | 0.5 | 1.0 | 2.0 | 5.0 |
| | | Blending amount | 75.0 | 75.0 | 25.0 | 50.0 | 100.0 | 250.0 |
| | | [mass parts/100 mass parts of | | | | | | |
| | | water-soluble thickener (A)] | | | | | | |
| Evaluation | Initial coulombic efficiency | | C | C | B | B | B | C |
| | Initial resistance | | C | C | B | B | B | C |
| | Cycle characteristics | | C | C | B | B | B | C |
| | Suppression of resistance increase after cycles | | C | C | B | B | B | C |
| | Adherence between negative-electrode mixed | | C | C | B | B | A | A |
| | material layer and current collector | | | | | | | |
| | | | Exam- | Exam- | Com. | Com. | Com. | Com. |
| | | | ple 22 | ple 23 | Example 4 | Example 5 | Example 6 | Example 7 |
| Slurry | Negative | Kind | Active | Active | Active | Active | Active | Active |
| compo- | electrode | | material 3 | material 3 | material 3 | material 3 | material 3 | material 3 |
| sition for | active | Blending amount [mass parts] | 100 | 100 | 100 | 100 | 100 | 100 |
| secondary- | material | | | | | | | |
| battery | Water-soluble | CMC1 blending amount [mass parts] | 1.84 | 1.60 | 0.39 | 1.96 | 1.96 | 1.96 |
| negative | thickener (A) | PAA1 blending amount [mass parts] | 0.16 | 0.40 | 0.01 | 0.04 | 0.04 | 0.04 |
| electrode | | PAA1/CMC1 + PAA1 [mass %] | 8.00 | 20.00 | 2.50 | 2.00 | 2.00 | 2.00 |
| | | Total blending amount [mass parts] | 2.00 | 2.00 | 0.40 | 2.00 | 2.00 | 2.00 |
| | Cross- | Kind | Cross- | Cross- | Cross- | Cross- | Cross- | Cross- |
| | linking | | linking | linking | linking | linking | linking | linking |
| | agent (B) | | agent B3 | agent B3 | agent B3 | agent B3 | agent B3 | agent B3 |
| | | Blending amount [mass parts] | 0.05 | 0.05 | 0.05 | 12.00 | 0.05 | 0.05 |
| | | Blending amount | 2.50 | 2.50 | 12.50 | 600.00 | 2.50 | 2.50 |
| | | [mass parts/100 mass parts of | | | | | | |
| | | water-soluble thickener (A)] | | | | | | |
| | Particulate | Kind | Polymer | Polymer | Polymer | Polymer | Polymer | — |
| | polymer (C) | | C1 | C1 | C1 | C1 | C1 | |
| | | Kind of funtional group | carboxyl | carboxyl | carboxyl | carboxyl | carboxyl | — |
| | | | group + | group + | group + | group + | group + | |
| | | | hydroxy | hydroxy | hydroxy | hydroxy | hydroxy | |
| | | | group | group | group | group | group | |
| | | Gel content [mass %] | 92 | 92 | 92 | 92 | 92 | — |
| | | Glass transition temperature | 10 | 10 | 10 | 10 | 10 | — |
| | | [degrees C.] | | | | | | |
| | | Blending amount [mass parts] | 2.0 | 2.0 | 1.5 | 1.5 | 22.0 | — |
| | | Blending amount | 100.0 | 100.0 | 375.0 | 75.0 | 1100.0 | — |
| | | [mass parts/100 mass parts of | | | | | | |
| | | water-soluble thickener (A)] | | | | | | |

| | | | | | | | |
|---|---|---|---|---|---|---|---|
| Evaluation | Initial coulombic efficiency | B | B | — | D | D | D |
| | Initial resistance | B | B | — | D | D | C |
| | Cycle characteristics | B | B | — | D | D | D |
| | Suppression of resistance increase after cycles | B | B | — | D | D | D |
| | Adherence between negative-electrode mixed | B | C | — | D | A | D |
| | material layer and current collector | | | | | | |

Tables 1 and 2 show that Examples 1 to 23, which use the predetermined water-soluble thickener (A), cross-linking agent (B), the particulate polymer (C), and negative electrode active material at certain ratios, can ensure the adherence between the negative-electrode mixed material layer and the current collector, and can improve the electrical characteristics of the lithium ion secondary battery.

In contrast, Table 1 shows that Comparative Examples 1 to 3, which do not contain the cross-linking agent (B), fail to improve the adherence between the negative-electrode mixed material layer and the current collector as well as the electrical characteristics of the lithium ion secondary battery.

Further, Table 2 shows that Comparative Example 4, which contains a less amount of the water-soluble thickener (A), does not even allow preparation of the slurry composition. Still further, Table 2 shows that Comparative Example 5, which contains a large amount of cross-linking agent (B), fails to improve the adherence between the negative-electrode mixed material layer and the current collector as well as the electrical characteristics of the lithium ion secondary battery, and that Comparative Example 6, which contains a large amount of particulate polymer (C), fails to improve the electrical characteristics of the lithium ion secondary battery. Table 2 further shows that Comparative Example 7, which contains no particulate polymer (C), fails to improve the adherence between the negative-electrode mixed material layer and the current collector as well as the electrical characteristics of the lithium ion secondary battery.

In particular, Examples 1 to 3 in Table 1 demonstrate that the change of the compound used as the cross-linking agent (B) allows even better adherence between the negative-electrode active material layer and the current collector as well as even better electrical characteristics, such as initial resistance and cycle characteristics, of the lithium ion secondary battery.

Further, Examples 3 to 6 in Table 1 demonstrate that the change in the amount of the cross-linking agent (B) allows suppression of resistance increase while achieving even better adherence between the negative-electrode active material layer and the current collector as well as even better electrical characteristics, such as initial resistance and cycle characteristics, of the lithium ion secondary battery.

Still further, Examples 3 and 7 in Table 1 demonstrate that the combined use of carboxymethyl cellulose and polyacrylic acid as the water-soluble thickener (A) allows the electrical characteristics of the lithium ion secondary battery and the adherence between the negative-electrode mixed material layer and the current collector to be concurrently achieved at a high level.

Still further, Examples 1 to 7 and 8 to 9 in Table 1 demonstrate that the use of the silicon-containing alloy as the negative electrode active material allows good electrical characteristics of the lithium ion secondary battery.

Example 9 in Table 1 and Examples 10 to 12 in Table 2 demonstrate that the change in the amount of the water-soluble thickener (A) allows suppression of resistance increase while achieving even better adherence between the negative-electrode mixed material layer and the current collector as well as even better electrical characteristics of the lithium ion secondary battery.

Further, Example 10 and Examples 13 to 17 in Table 2 demonstrate that the change in the amount of the cross-linking agent (B) allows suppression of resistance increase while achieving even better adherence between the negative-electrode active material layer and the current collector as well as even better electrical characteristics, such as initial resistance and cycle characteristics, of the lithium ion secondary battery.

Still further, Example 10 and Examples 18 to 21 in Table 2 demonstrate that the change in the amount of the particulate polymer (C) can ensure the electrical characteristics of the lithium ion secondary battery and achieve suppression of resistance increase while achieving even better adherence between the negative-electrode active material layer and the current collector.

Still further, Example 20 and Examples 22 to 23 in Table 2 demonstrate that the change in the ratio of carboxymethyl cellulose and polyacrylic acid used as the water-soluble thickener (A) allows even better adherence between the negative-electrode mixed material layer and the current collector.

### INDUSTRIAL APPLICABILITY

According to the slurry composition for a secondary battery negative electrode of the disclosure, even if a negative electrode active material containing a non-carbon-based negative electrode active material is used, a negative-electrode mixed material layer that exhibits superior adherence to a current collector and is capable of improving the electrical characteristics of a secondary battery can be formed.

According to the secondary-battery negative electrode of the disclosure that includes a negative electrode active material containing a non-carbon-based negative electrode active material, the adherence between a current collector and a negative-electrode mixed material layer can be improved and the electrical characteristics of a secondary battery can be also improved.

According to the secondary battery of the disclosure that comprises a secondary-battery negative electrode that includes a negative electrode active material containing a non-carbon-based negative electrode active material, the electrical characteristics can be improved and the adherence between a negative-electrode mixed material layer and a current collector can be ensured.

1. A slurry composition for a secondary-battery negative electrode, comprising a water-soluble thickener (A) having a hydroxy group or a carboxyl group, a cross-linking agent (B) having a functional group reactive with the hydroxy group or the carboxyl group of the water-soluble thickener (A), a particulate polymer (C), a negative electrode active material, and water, wherein
the negative electrode active material contains a non-carbon-based negative electrode active material,
the particulate polymer (C) has a functional group reactive with the cross-linking agent (B), and
the slurry composition for a secondary-battery negative electrode contains 0.5 mass parts or more but 20 mass parts or less of the water-soluble thickener (A), 0.001 mass parts or more but 10 mass parts or less of the cross-linking agent (B), and 0.5 mass parts or more but 20 mass parts or less of the particulate polymer (C), per 100 mass parts of the negative electrode active material.

2. The slurry composition for a secondary-battery negative electrode according to claim 1, wherein the water-soluble thickener (A) is at least one selected from the group consisting of carboxymethyl cellulose, methyl cellulose, hydroxypropyl methylcellulose, hydroxyethyl methylcellulose, polyvinyl alcohol, polycarboxilic acid, and salts thereof.

3. The slurry composition for a secondary-battery negative electrode according to claim 1, wherein the cross-linking agent (B) is at least one compound selected from the group consisting of a multifunctional epoxy compound, an oxazoline compound, and a carbodiimide compound.

4. The slurry composition for a secondary-battery negative electrode according to claim 1, wherein the particulate polymer (C) contains an aliphatic conjugated diene monomer unit and an aromatic vinyl monomer unit.

5. The slurry composition for a secondary-battery negative electrode according to claim 1, wherein the functional group reactive with the cross-linking agent (B) in the particulate polymer (C) is at least one group selected from the group consisting of a carboxyl group, a hydroxy group, a glycidyl ether group, and a thiol group.

6. A secondary-battery negative electrode, having a negative-electrode mixed material layer obtained from the slurry composition for a secondary-battery negative electrode according to claim 1.

7. The secondary-battery negative electrode according to claim 6, wherein the negative-electrode mixed material layer has a cross-linked structure formed from the water-soluble thickener (A), the cross-linking agent (B), and the particulate polymer (C).

8. A secondary battery comprising the secondary-battery negative electrode according to claim 6, a positive electrode, an electrolysis solution, and a separator.
